(19) United States
(12) Patent Application Publication
(10) Pub. No.: US 2026/0185660 A1
(43) Pub. Date: Jul. 2, 2026

(54) ELECTRIC-POWERED LUBRICANT DISPENSER, AND METHOD FOR DISPENSING LUBRICANT FROM ELECTRIC-POWERED LUBRICANT DISPENSER

(71) Applicant: MAKITA CORPORATION, Anjo-shi (JP)

(72) Inventors: Yuki HAYASHI, Anjo-shi (JP); Hidefumi Hagiwara, Anjo-shi (JP)

(73) Assignee: MAKITA CORPORATION, Anjo-shi (JP)

(21) Appl. No.: 19/430,668

(22) Filed: Dec. 23, 2025

(30) Foreign Application Priority Data
Dec. 27, 2024 (JP) 2024-233018

(51) Int. Cl. F16N 13/06; F16N 5/00

(52) U.S. Cl. CPC F16N 13/06; F16N 5/00; F16N 2013/066; F16N 2250/16; F16N 2270/70

(57) ABSTRACT

One aspect of the present disclosure provides an electric-powered lubricant dispenser including a motor, a pump, a drive circuit, and a control circuit. The pump includes a container for storing a lubricant and a reciprocating member. The control circuit performs a specified process based on the actual operating amount satisfying a specified requirement. The actual operating amount has a magnitude corresponding to the magnitude of a specific load applied to the motor. The specific load includes a first load and does not include at least part of a second load. The first load is based on a pressure from the lubricant. The second load is applied from the reciprocating member independently of the pressure.

### CROSS-REFERENCE TO RELATED APPLICATIONS

The present application claims the benefit of Japanese Patent Application No. 2024-233018 filed on Dec. 27, 2024 with the Japan Patent Office, the entire disclosure of which is incorporated herein by reference.

### BACKGROUND

The present disclosure relates to an electric-powered lubricant dispenser. Japanese Unexamined Patent Application Publication No. 2024-134818 discloses a grease dispenser equipped with a pump. In this grease dispenser, the pump receives grease from a tank and dispenses the grease.

### SUMMARY

In the grease dispenser, air may become trapped inside the pump. Air entrapped inside the pump may interfere with proper dispensing of grease by the pump. For example, an amount of grease dispensed may temporarily decrease or grease may temporarily cease to be dispensed.

In one aspect of the present disclosure, it is desirable that presence of gas in a pump can be appropriately detected.

In the present disclosure, terms such as “first”, “second”, and the like only intend to distinguish one element from another, and do not intend to limit the order or the number of the elements. Accordingly, a first element may be referred to as a second element, and similarly, a second element may be referred to as a first element. Additionally, a first element may be included without a second element, and similarly, a second element may be included without a first element.

One aspect of the present disclosure provides an electric-powered lubricant dispenser including a motor, a pump, a drive circuit, and a control circuit.

The pump includes a container and a reciprocating member. The container is configured to store a lubricant. The reciprocating member is configured (i) to reciprocate in a first direction and a second direction opposite thereto within the container, and (ii) to dispense the lubricant in the container to outside the container in response to the reciprocating member moving in the first direction.

The motor drives the reciprocating member. The motor receives a motor load. The motor load includes a first load and a second load. The first load is applied to the motor from the reciprocating member due to a pressure that the reciprocating member receives from the lubricant. The second load is applied to the motor from the reciprocating member independent of the pressure.

The drive circuit is configured to drive the motor.

The control circuit rotates the motor via the drive circuit. The control circuit performs a specified process based on an actual operating amount satisfying a specified requirement during driving of the motor. The actual operating amount has a magnitude corresponding to a magnitude of a specific load. The specific load is at least part of the motor load. The specified requirement is a condition indicating that gas is present in the container.

The specific load includes the first load and does not include at least part of the second load.

The electric-powered lubricant dispenser configured as such can appropriately detect that the gas is present in the container (that is, in the pump).

Another aspect of the present disclosure is a method for dispensing a lubricant from an electric-powered lubricant dispenser, the method including:
reciprocating a reciprocating member by a motor to dispense the lubricant in a container, the motor being configured to receive a motor load, the motor load including (i) a first load applied to the motor from the reciprocating member due to a pressure that the reciprocating member receives from the lubricant and (ii) a second load applied to the motor from the reciprocating member independent of the pressure; and
performing a specified process based on an actual operating amount satisfying a specified requirement during driving of the motor, the specified requirement being a condition indicating that gas is present in the container, the actual operating amount having a magnitude corresponding to a magnitude of a specific load, the specific load (i) being at least part of the motor load and (ii) including the first load and not including at least part of the second load.

With the method as above, it is possible to appropriately detect that the gas is present in the container in the electric-powered lubricant dispenser.

### BRIEF DESCRIPTION OF THE DRAWINGS

An example embodiment of the present disclosure will be described hereinafter with reference to the accompanying drawings, in which:

FIG. 1 is a perspective view of an electric-powered lubricant dispenser in a first embodiment;

FIG. 2 is a central longitudinal sectional view of the electric-powered lubricant dispenser;

FIG. 3 is an explanatory diagram illustrating a mechanism by which a plunger moves up and down due to rotation of a motor;

FIG. 4 is a plan view of an operation panel of the electric-powered lubricant dispenser;

FIG. 5 is a circuit diagram showing an electrical configuration of the electric-powered lubricant dispenser;

FIG. 6 is a function block diagram of a control circuit in the electric-powered lubricant dispenser;

FIG. 7 is an explanatory diagram schematically illustrating a load and a torque applied to the motor;

FIG. 8 is an explanatory diagram schematically illustrating that a motor load includes first through third loads;

FIG. 9 is an explanatory diagram showing an example operation of the electric-powered lubricant dispenser in a normal state and a low-temperature environment;

FIG. 10 is an explanatory diagram showing an example operation of the electric-powered lubricant dispenser in the normal state and a high-temperature environment;

FIG. 11 is an explanatory diagram showing an example operation of the electric-powered lubricant dispenser in an air entrapped state and a low-temperature environment;

FIG. 12 is an explanatory diagram showing an example operation of the electric-powered lubricant dispenser in the air entrapped state and a high-temperature environment;

FIG. 13 is an explanatory diagram illustrating a moving average of a load physical quantity in the air entrapped state and a low-temperature environment;

FIG. 14 is an explanatory diagram illustrating the moving average of the load physical quantity in the normal state and a high-temperature environment;

FIG. 15 is an explanatory diagram showing an example setting of a first current threshold;

FIG. 16 is a flowchart of a main process;

FIG. 17 is a flowchart of a stoppage process;

FIG. 18 is a flowchart of an in-operation process;

FIG. 19 is a flowchart of an air entrapment detection process of the first embodiment;

FIG. 20 is a flowchart of a duration determination process;

FIG. 21 is a flowchart of the air entrapment detection process of a second embodiment;

FIG. 22 is a flowchart of the air entrapment detection process of a third embodiment;

FIG. 23 is an explanatory diagram illustrating a first level and a second level of the load physical quantity in the air entrapped state and a low-temperature environment;

FIG. 24 is an explanatory diagram illustrating the first level and the second level of the load physical quantity in the normal state and a high-temperature environment;

FIG. 25 is a flowchart of part of the air entrapment detection process of a fourth embodiment;

FIG. 26 is a flowchart of another part (continued from FIG. 25) of the air entrapment detection process of the fourth embodiment;

FIG. 27 is a flowchart of part of the air entrapment detection process of a fifth embodiment;

FIG. 28 is a flowchart of another part (continued from FIG. 27) of the air entrapment detection process of the fifth embodiment;

FIG. 29 is a flowchart of part of the air entrapment detection process of a sixth embodiment; and

FIG. 30 is a flowchart of another part (continued from FIG. 29) of the air entrapment detection process of the sixth embodiment.

### DETAILED DESCRIPTION OF EXEMPLARY EMBODIMENTS

### 1. Overview of Embodiments

One embodiment may provide an electric-powered lubricant dispenser (or a handheld electric-powered lubrication dispenser, or an electric-powered lubricant supply device) including at least any one of:
Feature 1: a pump;
Feature 2: the pump includes a container;
Feature 3: the container is configured to contain (or store) a lubricant;
Feature 4: the pump includes a reciprocating member, and the reciprocating member may be at least partially disposed in the container;
Feature 5: the reciprocating member is configured to reciprocate in a first direction and a second direction within the container, the second direction being a direction opposite to the first direction, wherein the reciprocating member may be configured to directly or indirectly receive rotation of the motor and thereby reciprocate;
Feature 6: the reciprocating member is configured to dispense the lubricant in the container to outside the container in response to the reciprocating member moving in the first direction;
Feature 7: a motor;
Feature 8: the motor is configured to drive the reciprocating member;
Feature 9: the motor is configured to receive a motor load;
Feature 10: the motor load includes a first load;
Feature 11: the first load is applied to the motor from the reciprocating member due to a pressure that the reciprocating member receives from the lubricant;
Feature 12: the motor load includes a second load;
Feature 13: the second load is applied to the motor from the reciprocating member independent of the pressure (in other words, without the pressure), wherein the second load may be defined as a load applied to the motor (i) from the reciprocating member by reciprocation of the reciprocating member itself or (ii) due solely to the reciprocation of the reciprocating member;
Feature 14: a drive circuit;
Feature 15: the drive circuit is configured to drive the motor;
Feature 16: a control circuit;
Feature 17: the control circuit is configured to rotate the motor via the drive circuit (in other words, execute a first operation), wherein the control circuit may control the drive circuit to thereby rotate the motor;
Feature 18: the control circuit is configured to perform a specified process (in other words, execute a second operation) based on an actual operating amount satisfying a specified requirement during driving of the motor;
Feature 19: the actual operating amount has a magnitude corresponding to a magnitude of a specific load, wherein the actual operating amount may be a physical quantity;
Feature 20: the specific load is at least part of the motor load, in other words, the specific load is included in the motor load;
Feature 21: the specific load includes the first load;
Feature 22: the specific load does not include at least part of the second load; and
Feature 23: the specified requirement is a condition (or index) indicating (or specifying) that gas (or bubbles) is present in the container, wherein the specified requirement may be satisfied in response to the gas being present in the container (that is, the gas is mixed into lubricant within the container, or the gas has entered the pump), or wherein the specified requirement may be satisfied in response to a specified volume or more of the gas being present in the container.

The electric-powered lubricant dispenser including at least Features 1 through 23 can appropriately detect that the gas is present in the container.

The motor is in the form of an electric motor. The motor may be configured to generate a driving force (or a rotational driving force, or a driving torque, or a rotational force, or a torque). The reciprocating member may be configured (i) to directly or indirectly receive the driving force from the motor, and (ii) to be driven by the driving force.

The motor may be configured (i) to receive electric current to thereby rotate, and (ii) to output the driving torque (or the torque or the rotational force) corresponding to the electric current. The motor may receive the electric current from the drive circuit.

Examples of the motor include a DC motor, an AC motor, and a stepping motor. Examples of the DC motor include a brushless motor (or a brushless DC motor) and a brushed DC motor.

Examples of the lubricant include a liquid lubricant and a semi-solid lubricant. Examples of the liquid lubricant include lubricating oil. Examples of the semi-solid lubricant include grease. That is, examples of the electric-powered lubricant dispenser include an electric grease gun.

The motor load is a load applied to the motor from outside the motor. The motor load includes a load generated by the reciprocating member and applied to the motor (hereinafter referred to as the “pump load”). The pump load includes the first load and the second load. The specific load is part of the pump load. The specific load may be defined as the pump load with at least part of the second load removed. Most or all of the specific load may be the first load.

The first load may have a magnitude corresponding to the pressure. The first load may be applied from the reciprocating member when the pressure is received by the reciprocating member from the lubricant during movement of the reciprocating member in the first direction (i.e., during dispensing of the lubricant).

The second load may be defined as, for example, a load applied to the motor by reciprocation of the reciprocating member when the container is open and the lubricant is absent. Due to mechanical factors (for example, sliding resistance) of the reciprocating member and/or its surroundings, output torque from the motor is required even when the lubricant is absent in the container (that is, merely to reciprocate the reciprocating member). The load corresponding to the output torque can be said to be the second load. The sliding resistance may be generated by friction between the reciprocating member and other members in contact with the reciprocating member. The other members may include an inner wall facing the reciprocating member in the container.

The reciprocating member may be configured to reciprocate in a specified range of movement. The reciprocating member may be configured to move linearly (that is, reciprocate along a straight line). The electric-powered lubricant dispenser may include a converter that converts rotational motion into linear motion. The converter is (i) directly or indirectly coupled to the motor and the reciprocating member, (ii) receives rotation from the motor, and (iii) converts that rotation into reciprocating motion of the reciprocating member. The converter may be one of multiple components that make up the pump.

The pump may be configured such that the lubricant is supplied to the container in response to the reciprocating member moving in the second direction. The pump may include a dispensing port communicating with the container. The lubricant may be dispensed from the dispensing port to outside the container (and thus to outside the pump, and further to outside the electric-powered lubricant dispenser) in response to the reciprocating member moving in the first direction.

The lubricant may be stored (or filled) in the container in any manner. The container may include an inflow hole for receiving the lubricant from outside the pump. The lubricant may flow into the container through the inflow hole by receiving a pressure at the inflow hole from outside the pump. The container may be configured such that (i) a negative pressure is generated in the container in response to the reciprocating member moving in the second direction, and (ii) the negative pressure causes the lubricant to flow (i.e., be sucked) into the container from outside the pump through the inflow hole.

The pump may include any form capable of dispensing the lubricant by reciprocation of the reciprocating member. The pump may be configured such that the volume of the container changes by reciprocation of the reciprocating member, thereby dispensing the lubricant. Examples of the pump include a positive displacement pump (more specifically, for example, a reciprocating pump). Examples of the reciprocating pump include a plunger pump, a piston pump, and a diaphragm pump. Examples of the reciprocating member include a plunger, a piston, and a diaphragm.

Examples of the container include a chamber and a cylinder. In the diaphragm pump, the diaphragm forms part of the chamber.

The drive circuit may include multiple switch elements electrically coupled to the motor. Examples of the drive circuit include a full-bridge circuit and a half-bridge circuit.

The full-bridge circuit may be electrically coupled to the motor. In this case, the motor may be in the form of a three-phase motor (for example, the brushless motor). The motor may (i) have three terminals, and (ii) be configured to receive electric power from the full-bridge circuit (that is, the drive circuit) via the three terminals to thereby rotate.

The full-bridge circuit may include six switch elements. Examples of each of the six switch elements include a semiconductor switch and a mechanical relay. Examples of the semiconductor switch include a field-effect transistor (FET), a bipolar transistor, an insulated gate bipolar transistor (IGBT), a thyristor, and a solid-state relay (SSR).

The six switch elements may include three high-side switches and three low-side switches. The three high-side switches may be electrically coupled to a positive electrode of a power source (for example, a DC power source) and the three terminals of the motor. The three low-side switches may be electrically coupled to a negative electrode of the power source and the three terminals of the motor. Each of the three high-side switches may be (i) disposed on a corresponding one of the three positive-side current paths and (ii) configured to complete or interrupt the positive-side current path. Each of the three positive-side current paths electrically couple a corresponding one of the three terminals of the motor to the positive electrode of the power source. Each of the three low-side switches may be (i) disposed on a corresponding one of the three negative-side current paths and (ii) configured to complete or interrupt the three negative-side current paths. Each of the three negative-side current paths electrically couple a corresponding one of the three terminals of the motor to the negative electrode of the power source.

Here, a normal state and a gas-mixed state are defined. The normal state is a state where the container is filled with the lubricant and no gas is present in the container (or in the lubricant). The gas-mixed state is a state where gas is present in the container. The gas-mixed state corresponds to an air entrapped state described later.

In the normal state, the first load (i) increases significantly when the reciprocating member moves in the first direction, and (ii) decreases substantially or becomes zero when the reciprocating member moves in the second direction. That is, the first load alternately increases and decreases with each reciprocation of the reciprocating member. In other words, the first load fluctuates periodically, with one reciprocation of the reciprocating member as one cycle.

On the other hand, when in the gas-mixed state and the reciprocating member is moving in the first direction, the first load is lower than the first load when in the normal state and the reciprocating member is moving in the first direction. Therefore, an increase/decrease range (i.e., fluctuation range) of the first load in the gas-mixed state is smaller than the fluctuation range of the first load in the normal state.

Therefore, if the second load is not included in the motor load, it is possible to determine whether the gas is present in the container based on the motor load (or load physical quantity). This is because, in this case, most, nearly all, or all of the motor load can be the first load. In other words, fluctuation in the motor load in this case can be regarded as fluctuation in the first load.

However, in practice, torque is required solely to reciprocate the reciprocating member, so the motor load includes the second load. Moreover, the second load may also fluctuate in accordance with the reciprocation of the reciprocating member.

The second load is independent of the pressure received from the lubricant. Therefore, the second load may fluctuate, for example, with each one-way movement of the reciprocating member. That is, the second load may fluctuate periodically, with each one-way movement of the reciprocating member as one cycle. The one-way movement means the reciprocating member moving from a first end to a second end of its travel path, and the reciprocating member moving from the second end to the first end. The first end is an end of the travel path in the first direction, and the second end is an end of the travel path in the second direction.

Therefore, determining whether the gas is present in the container based on the motor load is not easy, or is difficult, or is impossible.

In contrast, the control circuit having the above Feature 18 performs the specified process based on an actual operating amount satisfying the specified requirement. The actual operating amount indicates an operating state of the electric-powered lubricant dispenser and may include an amplitude of a filtered physical quantity described later, and a reciprocating difference. The specific load includes the first load while excluding some or all of the second load. Therefore, the control circuit can appropriately determine a state of gas present in the container and operate appropriately in accordance with the gas-mixed state.

The specified requirement may indicate that the gas may be present in the container. That is, the actual operating amount satisfying the specified requirement may mean that either the gas is actually present in the container or the gas may be present in the container.

The gas being present in the container may include cases in which (i) the gas is mixed into the lubricant in the container, and/or (ii) the lubricant is not present and there is only gas in the container.

The specified process may be any process in response to the gas being present in the container. The specified process may be a process that should be performed or is preferably performed when the gas is present in the container. When the gas is present in the container, the lubricant may not be dispensed normally. Specifically, an amount of the lubricant dispensed may decrease or the lubricant may cease to be dispensed. Therefore, the specified process may also be a process in response to a state where the lubricant may not be dispensed normally, that is, a process that should be performed or is preferably performed in such state. Examples of the specified process are described later.

In one embodiment, the control circuit may be integrated into a single electronic unit, a single electronic device, or a single circuit board.

In one embodiment, the control circuit may be a combination of two or more electronic circuits, two or more electronic units, or two or more electronic devices provided separately on or in the electric-powered lubricant dispenser.

In one embodiment, the control circuit may include a microcomputer (or a microcontroller or a microprocessor), a wired logic, an application-specific integrated circuit (ASIC), an application specific standard product (ASSP), a programmable logic device (PLD) (e.g., field-programmable gate array (FPGA)), a discrete electronic component, and/or combinations thereof.

In one embodiment, the electric-powered lubricant dispenser may be handheld (in other words, portable). That is, the electric-powered lubricant dispenser may include a grip designed to be grasped by a user of the electric-powered lubricant dispenser. The electric-powered lubricant dispenser may be used while the grip is grasped by the user.

One embodiment may include, in addition to or in place of at least any one of the above Features 1 through 23, at least any one of:
Feature 24: the pump includes a guide;
Feature 25: the guide supports the reciprocating member so that the reciprocating member can reciprocate; and
Feature 26: the reciprocating member is configured to move along the guide.

The second load may include a sliding load. The sliding load may be generated due to sliding resistance (or frictional resistance) between the reciprocating member and the guide. More than half, most, or all of the second load may include the sliding load. The greater the sliding resistance, the larger the proportion of the second load relative to the motor load. Consequently, it becomes more difficult to detect presence of gas based on the motor load.

The reciprocating member and/or the guide may be coated with a lubricating oil to reduce friction between the two. That is, the reciprocating member may be in contact with the guide via the lubricating oil. The lubricating oil is separate from the lubricant.

In this case, the second load (specifically, the sliding load) may change with temperature. This is because, generally, viscosity of the lubricating oil changes with temperature. Specifically, viscosity of the lubricating oil generally decreases (that is, softens) as the temperature increases and, conversely, increases (that is, hardens) as the temperature decreases. Therefore, the second load decreases as the temperature increases and conversely increases as the temperature decreases. That is, the proportion of the second load relative to the motor load changes with temperature. Consequently, it is difficult to accurately detect presence of gas in the container over a wide temperature range based on the motor load.

In contrast, the specific load does not include at least part of the second load. Therefore, influence of the second load on the specific load (and consequently the actual operating amount) is reduced or blocked.

Therefore, the electric-powered lubricant dispenser including at least Features 1 through 26 can appropriately detect that the gas is present in the container over a wide temperature range, even if sliding resistance is generated between the reciprocating member and the guide.

In one embodiment, the reciprocating member may have a protrusion, and the guide may have a groove. The protrusion may be fitted into the groove and may be movable along the groove with the reciprocating member in the first direction and the second direction. Conversely, the guide may have the protrusion and the reciprocating member may have the groove.

One embodiment may include, in addition to or in place of at least any one of the above Features 1 through 26, at least any one of:
Feature 27: the reciprocating member includes a plunger;
Feature 28: the plunger is at least partially disposed in the container;
Feature 29: the plunger is configured to reciprocate in the first direction and the second direction within the container;
Feature 30: the reciprocating member includes a slider;
Feature 31: the slider is mechanically coupled to the plunger; and
Feature 32: the slider is configured to move integrally with the plunger along the guide.

The electric-powered lubricant dispenser including at least Features 1 through 32 can appropriately detect that the gas is present in the container even when sliding resistance is generated between the slider and the guide.

The plunger may have a rod (or cylindrical) shape. At least a portion including one end of the plunger (hereinafter, referred to as “insertion portion”) may be inserted into the container and configured to reciprocate within the container. The insertion portion may be configured to apply a pressure to the lubricant in response to movement in the first direction, thereby dispensing the lubricant.

The plunger and the slider may be in the form of mutually independent parts. Alternatively, the plunger and the slider may be integrally formed with each other.

Part or all of the sliding resistance may include resistance generated between the slider and the guide. The lubricating oil may be applied to the slider and/or the guide. The protrusion or groove may be provided on the slider.

One embodiment may include, in addition to or in place of at least any one of the above features 1 through 32, at least any one of:
Feature 33: the actual operating amount includes an amplitude of a filtered physical quantity;
Feature 34: the filtered physical quantity is obtained by reducing or removing a component attributable to the second load from a load physical quantity; and
Feature 35: the load physical quantity is a physical quantity that varies depending on a magnitude of the motor load.

The electric-powered lubricant dispenser including at least Features 1 through 23 and 33 through 35 can appropriately detect that the gas is present in the container based on the physical quantity reflecting the motor load.

The control circuit may be configured to acquire or detect the load physical quantity. The electric-powered lubricant dispenser may include a detector configured to detect the load physical quantity. The detector may be configured to output a detection signal indicating the detected load physical quantity. The control circuit may acquire the load physical quantity based on the detection signal.

The load physical quantity and the filtered physical quantity may change over time (that is, as time passes). The amplitude of the filtered physical quantity may be defined as a difference between a local maximum (or local maximal value) and a local minimum (or local minimum value) occurring over time. That is, the filtered physical quantity may take a local maximum at a certain timing and then decrease to take a local minimum occurring consecutively in time series. The difference between the local maximum and the local minimum in this case corresponds to the amplitude. Conversely, the filtered physical quantity may take a local minimum at a certain timing and then increase to take a local maximum. The difference between the local minimum and the local maximum in this case also corresponds to the amplitude. The amplitude may be an amplitude in a specified drive period. The specified drive period may be any period during driving of the motor. The specified drive period may, for example, be one reciprocating period of the reciprocating member.

The control circuit may be configured to perform a first calculation process. The first calculation process includes calculating the filtered physical quantity from the load physical quantity. The control circuit may perform the specified process based on the calculated filtered physical quantity satisfying the specified requirement. Examples of the first calculation process include any process that can reduce or remove a component attributable to the second load from the load physical quantity. The first calculation process may, for example, be implemented by a digital low-pass filter. A cutoff frequency of the digital low-pass filter may, for example, be a reciprocal of time required for the one-way movement of the reciprocating member.

One embodiment may further include, in addition to or in place of at least any one of the above Features 1 through 35,
Feature 36: the filtered physical quantity is a moving average (i.e., the average value calculated using the moving average method) of the load physical quantity.

The moving average of the load physical quantity corresponds to the load physical quantity with a component attributable to the second load reduced or removed (i.e., the filtered physical quantity). Therefore, the actual operating amount in this case is an amplitude of the moving average.

Therefore, the electric-powered lubricant dispenser including at least Features 1 through 23 and 33 through 36 can easily detect that the gas is present in the container based on the moving average.

The first calculation operation may include a process to calculate the moving average of the load physical quantity. Examples of the moving average include a simple moving average, a weighted moving average, and an exponential moving average.

The control circuit may be configured to calculate the moving average of the load physical quantity. The control circuit may calculate the moving average at each repeatedly occurring calculation timing. The calculation timing may occur in any manner. The calculation timing may occur periodically or non-periodically. In one embodiment, the electric-powered lubricant dispenser may include a transmission mechanism (in other words, a reducer) (i) coupled to the motor and (ii) configured to decelerate rotation of the motor and transmit the decelerated rotation to the pump. In this case, the specific load may further include a third load. The third load is a load generated due to mechanical loss, such as friction, in the transmission mechanism. The transmission mechanism may include the converter. Alternatively, the converter may include the transmission mechanism.

When the specific load includes the third load, the moving average of the load physical quantity mainly contains the first load component and the third load component, while containing little or no second load component. Due to the general structure of the transmission mechanism, the third load is constant or substantially constant at least within the time period over which the moving average is calculated. Or, the third load can be considered constant or substantially constant at least within the time period over which the moving average is calculated. If the third load is constant or substantially constant, the amplitude of the moving average of the load physical quantity is close to, nearly equal to, or equal to an amplitude of the first load.

One embodiment may include, in addition to or in place of at least any one of the above Features 1 through 36, at least any one of:
Feature 37: the moving average is an average of the load physical quantity within a calculation target time; and
Feature 38: the calculation target time is a half of required reciprocating time, the required reciprocating time being time required for the reciprocating member to complete one reciprocation.

The electric-powered lubricant dispenser including at least Features 1 through 23 and 33 through 38 can easily and accurately detect that the gas is present in the container based on the moving average.

The load physical quantity may be acquired any number of times within the calculation target time and at any acquisition timing. The load physical quantity may, for example, be acquired periodically and repeatedly. The load physical quantity may be acquired at each calculation timing.

The control circuit may calculate an average of the load physical quantity within a calculation target period as the moving average at each calculation timing. The calculation target period is a period from a first timing to a second timing. The first timing is a timing that is the calculation target time earlier than the second timing. The second timing may be the calculation timing or may be predefined time earlier than the calculation timing.

The second load is independent of the pressure received from the lubricant. Therefore, it is expected that a first fluctuation in the second load and a second fluctuation in the second load will be similar or nearly equal to each other. The first fluctuation is a fluctuation in the second load during movement of the reciprocating member from the first end to the second end. The second fluctuation is a fluctuation in the second load during movement of the reciprocating member from the second end to the first end. In other words, it is expected that the second load will fluctuate repeatedly in a similar (or nearly identical) pattern, with one cycle being the one-way movement of the reciprocating member. Therefore, by calculating the moving average over half the required reciprocating time (i.e., time required for one-way movement), the component attributable to the second load can be reduced or removed from the load physical quantity.

The calculation target time may be longer than half the required reciprocating time. The calculation target time may be time obtained by adding a predefined length of time to half the required reciprocating time. The predefined length of time may be shorter than, for example, ¼ (or ⅛, or 1/16) of the required reciprocating time.

One embodiment may include, in addition to or in place of at least any one of the above Features 1 to 38, at least any one of:
Feature 39: the control circuit is configured to set a desired rotational speed (or target rotational speed), which is a desired (or target) value for a rotational speed of the motor;
Feature 40: the control circuit is configured to control the drive circuit so that an actual rotational speed of the motor is consistent with the desired rotational speed;
Feature 41: the control circuit is configured to obtain the calculation target time based on the set desired rotational speed; and
Feature 42: the control circuit is configured to calculate the moving average based on the acquired calculation target time.

The electric-powered lubricant dispenser including at least Features 1 through 23 and 33 through 42 can easily and more accurately detect that the gas is present in the container based on the moving average.

The actual rotational speed is an actual rotational speed of the motor. The actual rotational speed may be defined as a scalar quantity that does not take into account the rotational direction.

The required reciprocating time may become shorter as the desired rotational speed increases (or as the actual rotational speed increases) and may become longer as the desired rotational speed decreases (or as the actual rotational speed decreases). A first correspondence between the desired rotational speed (or the actual rotational speed) and the required reciprocating time, or a second correspondence between the desired rotational speed (or the actual rotational speed) and the calculation target time, can be known theoretically or experimentally in advance. Therefore, the required reciprocating time can be calculated (or equivalently, estimated) based on the desired rotational speed (or actual rotational speed) and the first correspondence, and the calculation target time can be calculated based on the required reciprocating time. Alternatively, the calculation target time can be calculated based on the desired rotational speed (or actual rotational speed) and the second correspondence. The control circuit may calculate the calculation target time at each calculation timing and calculate the moving average based on the calculation target time.

One embodiment may further include, in addition to or in place of at least any one of the above features 1 through 42,
Feature 43: the specified requirement includes a maximum value of the amplitude of the filtered physical quantity within the specified drive period being less than or equal to a first threshold; in other words, the specified requirement is satisfied based on the maximum value of the amplitude of the filtered physical quantity within the specified drive period being less than or equal to the first threshold.

An electric-powered lubricant dispenser including at least Features 1 through 23, 33 through 35, and 43 can appropriately and easily detect that the gas is present in the container based on the physical quantity reflecting the motor load.

The first threshold may be determined in any manner. The first threshold may be appropriately determined within a first specified range. The first specified range may be less than, for example, a minimum value of the amplitude of the filtered physical quantity that may occur in the normal state (e.g., obtained theoretically or experimentally). The first specified range may, for example, be greater than a maximum value of the amplitude of the filtered physical quantity that may occur in the gas-mixed state.

One embodiment may further include, in addition to or in place of at least any one of the above Features 1 through 43,
Feature 44: the control circuit is configured to set (i.e., change) the first threshold in accordance with an operating state of the electric-powered lubricant dispenser.

The electric-powered lubricant dispenser including at least Features 1 through 23, 33 through 35, 43, and 44 can accurately detect that the gas is present in the container based on the physical quantity reflecting the motor load.

The operating state may include any state that affects the load physical quantity. In other words, the operating state may include any condition where the load physical quantity (and consequently the filtered physical quantity) may change in response to a change in the operating state. Examples of the operating state are described later.

One embodiment may include, in addition to or in place of at least any one of the above Features 1 through 44, at least one of:
Feature 45: the drive circuit is configured to supply electric current to the motor to rotate the motor; and
Feature 46: the load physical quantity includes a magnitude of the electric current being supplied from the drive circuit to the motor (hereinafter referred to as the “motor current”).

The magnitude of the motor current (e.g., motor current value) varies depending on the motor load. Specifically, the motor current may increase as the motor load increases, and may decrease as the motor load decreases. Fluctuation in the motor current may include a component based on the fluctuation in the second load.

In contrast, the filtered physical quantity based on the motor current is one in which the component based on the fluctuation in the second load is reduced or removed from the magnitude of the motor current. Therefore, the control circuit can perform an appropriate process in accordance with the state of gas present in the container based on the amplitude of the filtered physical quantity.

Therefore, the electric-powered lubricant dispenser including at least Features 1 through 23, 33 through 35, 45, and 46 can appropriately detect that the gas is present in the container based on the motor current.

The electric-powered lubricant dispenser may include a current detector configured to output a current detection signal corresponding to a magnitude of the motor current. The control circuit may acquire the current detection signal and obtain the magnitude of the motor current based on the acquired current detection signal.

One embodiment may further include, in addition to or in place of at least any one of the above Features 1 through 46,
Feature 47: the load physical quantity includes an actual rotational speed of the motor.

The actual rotational speed varies depending on the motor load. Specifically, the actual rotational speed may decrease as the motor load increases and may increase as the motor load decreases. Fluctuation in the actual rotational speed may include a component based on the fluctuation in the second load.

In contrast, the filtered physical quantity based on the actual rotational speed is one from which the component based on the fluctuation of the second load has been reduced or removed. Therefore, the control circuit can perform an appropriate process in accordance with the state of gas present in the container based on the amplitude of the filtered physical quantity.

Therefore, the electric-powered lubricant dispenser including at least Features 1 through 23, 33 through 35, and 47 can appropriately detect that the gas is present in the container based on the actual rotational speed.

The electric-powered lubricant dispenser may include a rotation detector configured to output a rotation detection signal corresponding to the actual rotational speed. The control circuit may acquire the rotation detection signal and acquire the actual rotational speed based on the acquired rotation detection signal.

One embodiment may further include, in addition to or in place of at least any one of the above Features 1 through 47,
Feature 48: the load physical quantity includes a load torque, which is a torque being applied to the motor from outside the motor.

The load torque varies depending on the motor load. Specifically, the load torque may increase as the motor load increases and may decrease as the motor load decreases. Fluctuation in the load torque may include a component based on the fluctuation in the second load.

In contrast, the filtered physical quantity based on the load torque is one from which the component based on the fluctuation in the second load has been reduced or removed. Therefore, the control circuit can perform an appropriate process in accordance with the state of gas present in the container based on the amplitude of the filtered physical quantity.

Therefore, the electric-powered lubricant dispenser including at least Features 1 through 23, 33 through 35, and 48 can appropriately detect that the gas is present in the container based on the load torque.

The control circuit may acquire (for example, calculate) the load torque in any manner. For example, the control circuit may calculate (for example, estimate) the load torque based on a formula (1) below.

$${τ}_{o u t} = {K}_{τ} {I}_{m} - J {\dot{v}}_{m} \qquad ( 1 )$$

τₒᵤₜ: load torque
Iₘ: motor current value
K_{τ}: motor torque coefficient
J: moment of inertia
\dot{v}ₘ: motor acceleration

In the above formula (1), the motor current value is a value of the electric current supplied from the drive circuit to the motor. The motor torque coefficient is a torque coefficient of the motor. The moment of inertia is the moment of inertia of the motor. The motor acceleration is an acceleration of the motor (specifically, acceleration in the rotational direction of a rotational axis of the motor; in other words, angular acceleration). The torque coefficient is also referred to as a torque constant.

One embodiment may further include, in addition to or in place of at least any one of the above Features 1 through 48, at least any one of:
Feature 49: the actual operating amount includes a reciprocating difference of a load physical quantity in one reciprocating period, the one reciprocating period corresponding to a period during which the reciprocating member completes one reciprocation, and the load physical quantity being a physical quantity that varies depending on the magnitude of the motor load;
Feature 50: the reciprocating difference is a difference between a first level and a second level, the first level indicating the magnitude of the load physical quantity in a first period, and the second level indicating the magnitude of the load physical quantity in a second period; and
Feature 51: the first period is a period, within the one reciprocating period, during which the reciprocating member moves in the first direction, and the second period is a period, within the one reciprocating period, during which the reciprocating member moves in the second direction.

The second load is generated with each reciprocation of the reciprocating member, independent of the pressure from the lubricant. Therefore, the second load can be generated periodically with each one-way movement of the reciprocating member (i.e., half-cycle of one reciprocation).

Furthermore, it can be inferred that the magnitude and fluctuation pattern of the second load in the first period are similar to or equal to those of the second load in the second period, without significant difference. Therefore, obtaining the difference between the first level and the second level can reduce or remove the influence of the second load on the actual operating amount. If the magnitude and fluctuation pattern of the second load in the first period are completely consistent with those in the second period, the reciprocating difference will be completely free from influence of the second load. Consequently, based on the reciprocating difference, it is possible to appropriately determine whether the gas is present in the container.

The third load can generally be considered constant or substantially constant. Therefore, even if the motor load includes the third load, the reciprocating difference will be substantially or completely free from influence of the third load.

Therefore, an electric-powered lubricant dispenser including at least Features 1 through 23 and 49 through 51 can appropriately detect that the gas is present in the container based on the reciprocating difference.

The first level may be expressed in any form (e.g., value, amount, etc.) indicating the magnitude (or level) of the load physical quantity in the first period. The first level may be expressed in a manner that allows comparison with at least the second level (in other words, a significant difference may occur) regarding the magnitude of the load physical quantity in the first period. The second level may be expressed in a manner that allows comparison with at least the first level regarding the magnitude of the load physical quantity in the second period.

The control circuit may be configured to perform a second calculation process. The second calculation process includes calculating a reciprocating difference from the load physical quantity. The second calculation process may include (i) a process for calculating the first level; (ii) a process for calculating the second level, and (iii) a process for calculating the reciprocating difference based on the calculated first level and second level. The control circuit may perform the specified process based on the calculated reciprocating difference satisfying the specified requirement.

One embodiment may further include, in addition to or in place of at least any one of the above Features 1 through 51,
Feature 52: the specified requirement includes the reciprocating difference being less than or equal to a second threshold; in other words, the specified requirement is satisfied when the reciprocating difference is less than or equal to the second threshold.

The electric-powered lubricant dispenser including at least Features 1 through 23 and 49 through 52 can appropriately and easily detect that the gas is present in the container based on the reciprocating difference.

The second threshold may be determined in any manner. The second threshold may be appropriately determined within a second specified range. The second specified range may, for example, be less than the minimum value of the reciprocating difference that may occur in the normal state. The second specified range may, for example, be larger than the maximum value of the reciprocating difference that may occur in the gas-mixed state.

One embodiment may further include, in addition to or in place of at least any one of the above Features 1 through 52,
Feature 53: the control circuit is configured to set (that is, change) the second threshold in accordance with operating state of the electric-powered lubricant dispenser.

The electric-powered lubricant dispenser including at least Features 1 through 23 and 49 through 53 can accurately detect that the gas is present in the container based on the reciprocating difference.

One embodiment may further include, in addition to or in place of at least any one of the above Features 1 through 53, at least any one of:
Feature 54: the first level is an average or maximum value of the magnitude of the motor current in the first period; and
Feature 55: the second level is an average or maximum value of the magnitude of the motor current in the second period.

As described above, the magnitude of the motor current varies depending on the motor load. By taking the difference between the first level and the second level, a current component caused by the second load can be reduced or removed from the motor current. Therefore, based on the reciprocating difference, it is possible to determine whether the gas is present in the container.

Therefore, the electric-powered lubricant dispenser including at least Features 1 through 23, 45, 46, 49 through 51, 54, and 55 can appropriately detect that the gas is present in the container based on the motor current.

One embodiment may further include, in addition to or in place of at least any one of the above features 1 through 55, at least any one of:
Feature 56: the first level is an average or minimum value of the actual rotational speed in the first period; and
Feature 57: the second level is an average or minimum value of the actual rotational speed in the second period.

As described above, the actual rotational speed varies depending on the motor load. By taking the difference between the first level and the second level, a rotational speed component caused by the second load can be reduced or removed from the actual rotational speed. Therefore, based on the reciprocating difference, it is possible to determine whether the gas is present in the container.

Therefore, the electric-powered lubricant dispenser including at least Features 1 through 23, 47, 49 through 51, 56, and 57 can appropriately detect that the gas is present in the container based on the actual rotational speed.

One embodiment may further include, in addition to or in place of at least any one of the above Features 1 through 57, at least any one of:
Feature 58: the first level is an average or maximum value of the load torque in the first period; and
Feature 59: the second level is an average or maximum value of the load torque in the second period.

The load torque may be defined as a torque applied by the motor load. As described above, the load torque varies depending on the motor load. By taking the difference between the first level and the second level, a torque component caused by the second load can be reduced or removed from the load torque. Therefore, based on the reciprocating difference, it is possible to determine whether the gas is present in the container.

Therefore, the electric-powered lubricant dispenser including at least Features 1 through 23, 48, 49 through 51, 58, and 59 can appropriately detect that the gas is present in the container based on the load torque.

One embodiment may include, in addition to or in place of at least any one of the above Features 1 through 59, at least any one of:
Feature 60: a position detector configured to output a position signal corresponding to a position of the reciprocating member;
Feature 61: the control circuit is configured to receive the position signal; and
Feature 62: the control circuit is configured to calculate the reciprocating difference based on the first level in the first period and the second level in the second period, the first period and the second period being each determined based on the position signal.

The electric-powered lubricant dispenser including at least Features 1 through 23, 49 through 51, and 60 through 62 can easily and accurately determine the first period and the second period, and thereby can accurately calculate the reciprocating difference.

The position detector may be configured, for example, to output the position signal in response to the reciprocating member reaching a specific position in its travel path. The specific position may be, for example, a first end of the travel path or a second end of the travel path.

The control circuit may determine the first period and the second period based on the position signal. For example, the control circuit may determine the first period and the second period based on a timing at which the position signal is received, and the desired rotational speed or the actual rotational speed of the motor.

When the specific position is, for example, the first end, the control circuit may estimate arrival time until reaching the second end in response to receiving the position signal. The control circuit may estimate the arrival time based on the desired rotational speed or the actual rotational speed. The control circuit may then determine a period from the timing of receiving the position signal until the estimated arrival time elapses as the first period. The control circuit may further determine a period from an end of the first period until the next time the position signal is received as the second period.

Alternatively, the position detector may be able to detect when the reciprocating member reaches the first end and the second end. Specifically, the position detector may be configured (i) to output a first position signal in response to the reciprocating member reaching the first end, and (ii) to output a second position signal in response to the reciprocating member reaching the second end. In this case, the control circuit may determine a period from when the second position signal is received to when the first position signal is received as the first period, and determine a period from when the first position signal is received to when the second position signal is received as the second period.

One embodiment may further include, in addition to or in place of at least any one of the above Features 1 through 62,
Feature 63: the operating state includes the desired rotational speed.

The electric-powered lubricant dispenser including at least Features 1 through 23, 33 through 35, 39, 40, 43, 44, and 63, and the electric-powered lubricant dispenser including at least Features 1 through 23, 39, 40, 49 through 53, and 63, can detect that the gas is present in the container with greater accuracy.

One embodiment may further include, in addition to or in place of at least any one of the above Features 1 through 63, at least any one of:
Feature 64: the control circuit is configured to output a pulse width modulation signal to the drive circuit to control the drive circuit, and the pulse width modulation signal has a duty ratio;
Feature 65: the drive circuit is configured (i) to receive the pulse width modulation signal, and (ii) to drive the motor in accordance with the duty ratio of the received pulse width modulation signal; and
Feature 66: the operating state includes the duty ratio.

The electric-powered lubricant dispenser including at least Features 1 through 23, 33 through 35, 43, 44, and 64 through 66, and the electric-powered lubricant dispenser including at least Features 1 through 23, 49 through 53, and 64 through 66, can more accurately detect that the gas is present in the container.

The drive circuit may be configured to supply the motor current (or electric power) in accordance with the duty ratio to the motor to drive the motor. Specifically, the drive circuit may be configured to increase the motor current as the duty ratio increases. The duty ratio may increase as the desired rotational speed increases.

When the drive circuit includes multiple switch elements, at least one of the multiple switch elements may be configured (i) to receive the pulse width modulation signal and (ii) to be turned on or off (thereby completing or interrupting the corresponding current path) in accordance with the duty ratio of the pulse width modulation signal. That is, the larger the duty ratio, the longer the period during which the multiple switch elements are turned on (that is, the corresponding current path is completed), thereby increasing electric power supplied to the motor (and consequently an output of the motor and/or the actual rotational speed).

One embodiment may include, in addition to or in place of at least any one of the above Features 1 through 66,
Feature 67: the operating state includes the actual rotational speed of the motor.

The electric-powered lubricant dispenser including at least Features 1 through 23, 33 through 35, 43, 44, and 67, and the electric-powered lubricant dispenser including at least Features 1 through 23, 49 through 53, and 67, can detect that the gas is present in the container with greater accuracy.

The control circuit may set a target threshold (i.e., the first threshold or the second threshold) in any manner in accordance with the operating state. The control circuit may set the threshold in accordance with a pre-prepared function that uses the operating state as a variable. The control circuit may set the threshold by referring to a pre-prepared table or similar database. In the table, the operating state and the threshold are mutually associated. The control circuit may increase the threshold as the desired rotational speed increases. The control circuit may increase the threshold as the duty ratio increases.

One embodiment may include, in addition to or in place of at least any one of the above Features 1 through 67, at least any one of:
Feature 68: the control circuit is configured to acquire a temperature of the electric-powered lubricant dispenser; and
Feature 69: the operating state includes the temperature.

The electric-powered lubricant dispenser including at least Features 1 through 23, 33 through 35, 43, 44, 68, and 69, and the electric-powered lubricant dispenser including at least Features 1 through 23, 49 through 53, 68, and 69, can more accurately detect that the gas is present in the container.

The control circuit may acquire the temperature of any portion of the electric-powered lubricant dispenser. The temperature may be a temperature of the lubricant or a temperature that can be regarded as a temperature (or change in temperature) of the lubricant.

In one embodiment, the electric-powered lubricant dispenser may include a temperature detector configured and positioned to detect the temperature of the lubricant directly or indirectly. The control circuit may change the threshold in response to the temperature detected by the temperature detector. The temperature detector may be in direct contact with the lubricant. In this case, the temperature detector can directly detect the temperature of the lubricant. Alternatively, the temperature detector may be apart from the lubricant. The temperature detector may be in any form capable of detecting the temperature. Examples of the temperature detector include a positive temperature coefficient (PTC) thermistor, a negative temperature coefficient (NTC) thermistor, and a critical temperature resistor (CTR) thermistor.

The control circuit may be configured to lower the first threshold or the second threshold as the acquired temperature increases.

The operating state may also include elements other than the desired rotational speed, the duty ratio, the actual rotational speed, and the temperature. Examples of the operating state include a magnitude of a voltage applied from the drive circuit to the motor, or a physical quantity indirectly indicating the magnitude of the voltage. If the drive circuit is configured to apply a voltage of a power source (e.g., a battery) to the motor, the operating state may include the voltage of the battery. In this case, as the battery voltage decreases, the voltage applied to the motor also decreases. Therefore, the first threshold may be set to decrease as the battery voltage decreases. The same applies to the second threshold. One embodiment may include a voltage detector configured to detect the voltage of the battery. The voltage detector may be configured (i) to receive the voltage of the battery and (ii) to output a voltage detection signal corresponding to a magnitude of the voltage to the control circuit. The control circuit may (i) obtain the magnitude of the voltage of the battery based on the voltage detection signal from the voltage detector and (ii) set the first threshold (or the second threshold) based on the obtained magnitude.

One embodiment may further include, in addition to or in place of at least any one of the above Features 1 through 69, at least any one of:
Feature 70: a notifier configured to notify the user of information indicating the presence of gas in the container; and
Feature 71: the specified process includes notifying the user of the information via the notifier.

In the electric-powered lubricant dispenser including at least Features 1 through 23, 70, and 71, the user of the electric-powered lubricant dispenser can easily understand that the gas is present (or may be present) in the container.

The notifier may notify the user of the information by any method. The notifier may, for example, be configured to visually display the information. The notifier may, for example, be configured to output the information by sound or voice.

One embodiment may include, in addition to or in place of at least any one of the above Features 1 through 71, at least any one of:
Feature 72: the control circuit is configured to accumulate the actual reciprocating count of the reciprocating member during driving of the motor, the actual reciprocating count being the actual number of reciprocations of the reciprocating member;
Feature 73: the control circuit is configured to stop the motor based on the actual reciprocating count reaching a desired reciprocating count; and
Feature 74: the specified process includes temporarily stopping accumulation of the actual reciprocating count.

The electric-powered lubricant dispenser including at least Features 1 through 23 and 72 through 74 can inhibit or stop an actual dispensed amount of the lubricant, until the motor is stopped, from becoming less than a predefined amount corresponding to the desired reciprocating count.

One embodiment may further include, in addition to or in place of at least any one of the above Features 1 through 74,
Feature 75: the control circuit is configured to resume the accumulation of the actual reciprocating count after temporarily stopping the accumulation, based on the actual operating amount no longer satisfying the specified requirement.

The electric-powered lubricant dispenser including at least Features 1 through 23 and 72 through 75 can accurately dispense the predefined amount of the lubricant even if the gas is temporarily present in the container during driving of the motor.

One embodiment may further include, in addition to or in place of at least any one of the above Features 1 through 75,

Feature 76: the control circuit is configured to stop the motor based on a state in which the actual operating amount satisfies the specified requirement continuing for a specified time during driving of the motor.

The electric-powered lubricant dispenser including at least Features 1 through 23 and 76 allows the user to take appropriate action when the state in which the gas is (or may be) present persists. In one embodiment, the motor may be stopped without waiting for the specified time to elapse, in response to the specified requirement being satisfied.

One embodiment may further include, in addition to or in place of at least any one of the above Features 1 through 76,
Feature 77: the control circuit is configured to detect, during driving of the motor, that the gas is present in the container and/or that the pump is attempting to dispense the gas, in response to the specified requirement being satisfied.

The electric-powered lubricant dispenser including at least Features 1 through 23 and 77 enables various actions to be taken against the presence of gas.

One embodiment may provide a method for dispensing a lubricant from an electric-powered lubricant dispenser, the method including at least one of:
Feature 78: reciprocating a reciprocating member by a motor to dispense the lubricant in a container, wherein the motor may be configured to receive a motor load, the motor load may include a first load and a second load, the first load is applied from the reciprocating member to the motor due to a pressure that the reciprocating member receives from the lubricant, and the second load is applied from the reciprocating member to the motor independently of the pressure; and
Feature 79: performing a specified process during driving of the motor based on an actual operating amount satisfying a specified requirement, wherein the actual operating amount may have a magnitude corresponding to a magnitude of a specific load, the specific load may be at least part of the motor load, the specified requirement may be a condition indicating that the gas is present in the container, the specific load may include the first load, and the specific load need not include at least part of the second load.

According to the method including at least Features 78 and 79, the presence of gas in the container can be appropriately detected.

In one embodiment, the above Features 1 through 79 may be combined in any combination.

In one embodiment, any of the above Features 1 through 79 may be excluded.

### 2. Specific Example Embodiments

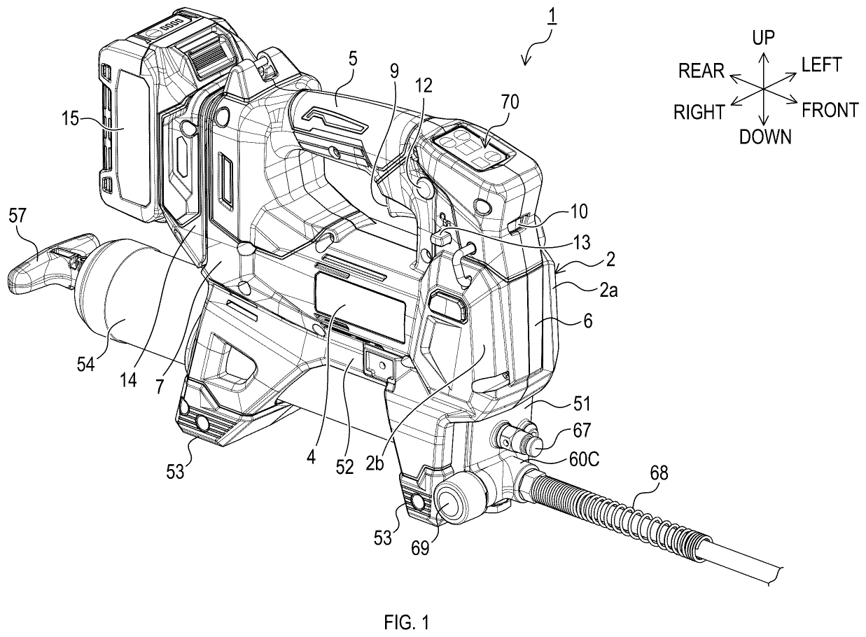

The following example embodiments provide an electric-powered lubricant dispenser 1 shown in FIG. 1. The electric-powered lubricant dispenser 1 is configured to dispense a lubricant. Specifically, the electric-powered lubricant dispenser 1 of the present embodiment is an electric-powered grease gun configured to dispense grease.

For convenience of explanation, directions in the electric-powered lubricant dispenser 1 are defined as shown appropriately in FIG. 1 and subsequent figures. Specifically, “up” (upward direction), “down” (downward direction), “right” (rightward direction), “left” (leftward direction), ‘front’ (forward direction), and “rear” (rearward direction) are defined. These directions are used solely to facilitate understanding of the structure of the electric-powered lubricant dispenser 1 and are not intended to limit the orientation of the electric-powered lubricant dispenser 1. The electric-powered lubricant dispenser 1 can be oriented in any direction.

### 2-1. First Embodiment

### 2-1-1. Mechanical Configuration of Electric-Powered Lubricant Dispenser

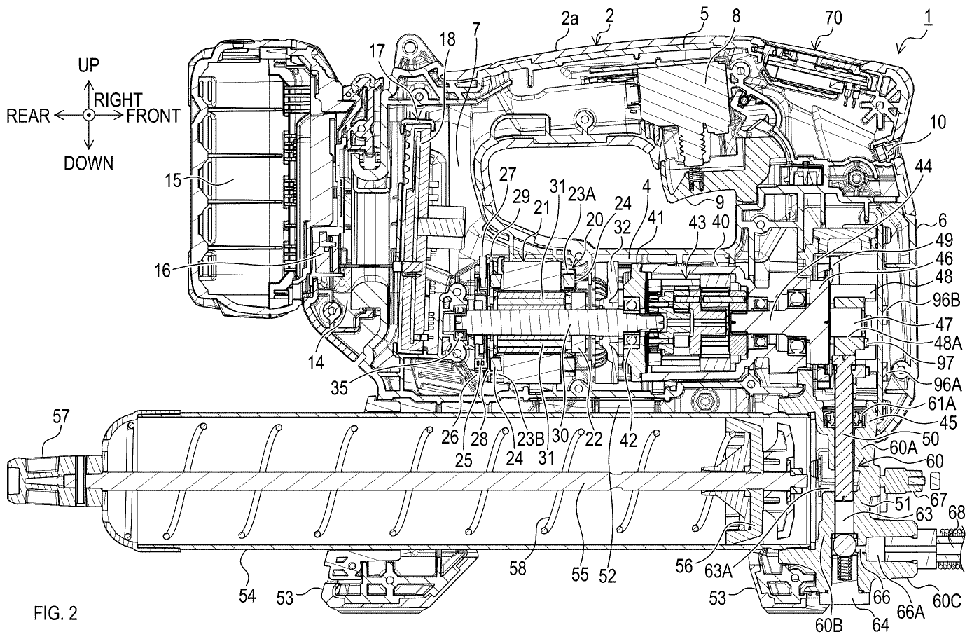

As shown in FIGS. 1 and 2, the electric-powered lubricant dispenser 1 of the first embodiment includes a housing 2. The housing 2 includes a first half housing 2a and a second half housing 2b joined together.

The housing 2 includes a motor container 4 at a central portion in its height direction. The height direction corresponds to a direction from bottom to top or from top to bottom of the housing 2. In the first embodiment, the motor container 4 has a cylindrical shape and extends in a length direction. The length direction corresponds to a direction from front to rear or from rear to front of the housing 2. The motor container 4 houses a motor 20. The motor 20 is an electric motor.

The housing 2 includes a grip 5 on its top. In the first embodiment, the grip 5 extends in the length direction and is bent downward. The motor container 4 includes a front joint portion 6 at its front end. The front joint portion 6 is joined to a front end of the grip 5. The motor container 4 includes a rear joint portion 7 at its rear end. The rear joint portion 7 is joined to a rear end of the grip 5. In the first embodiment, the rear joint portion 7 stands upward so as to form a space between the motor container 4 and the grip 5.

The electric-powered lubricant dispenser 1 includes a trigger switch 8 disposed in the grip 5. The electric-powered lubricant dispenser 1 includes a trigger 9 for a user of the electric-powered lubricant dispenser 1 to manually operate the trigger switch 8.

The trigger 9 is pulled by the user to drive the motor 20 (that is, to dispense grease). The trigger 9 is configured to be movable between an initial position and a maximum position. When the trigger 9 is not manually operated, the trigger 9 remains in the initial position. The trigger 9 moves from the initial position toward the maximum position as the trigger 9 is manually operated.

When the trigger 9 is positioned between the initial position and a minimum position, the trigger switch 8 is off, and the motor 20 is stopped. The minimum position is located between the initial position and the maximum position. When the trigger 9 is positioned between the minimum position and the maximum position, the trigger switch 8 is on, and the motor 20 can rotate. In the first embodiment, the trigger 9 protrudes downward from the grip 5.

The grip 5 includes a light 10 at its front. In the first embodiment, the light 10 includes a not shown light emitting diode (LED) as a light source.

The grip 5 includes an operation panel 70 on its front upper surface. The operation panel 70 is configured to be manually operated by the user to turn on or off the light 10 and to change settings of the electric-powered lubricant dispenser 1.

The grip 5 includes a first lock button 12 at the front of the trigger 9. The first lock button 12 is configured to be depressed by the user to lock the trigger 9 in the maximum position. The grip 5 includes a second lock button 13 below the first lock button 12. The second lock button 13 is configured to be depressed by the user to lock the trigger 9 in the initial position (that is, non-pulled position).

The rear joint portion 7 includes a battery holder 14 at its rear end. The battery holder 14 is configured so that the battery pack 15 is detachably attached to the battery holder 14. In the first embodiment, the battery holder 14 is configured so that the battery pack 15 is attached to the battery holder 14 by sliding the battery pack 15 from top to bottom at the rear end of the battery holder 14.

The battery pack 15 includes a not shown battery inside. In the first embodiment, the battery has a rated voltage of 36 volts.” The battery pack 15 supplies electric power of the battery to the electric-powered lubricant dispenser 1 via the battery holder 14.

The battery holder 14 includes a terminal block 16 inside. The terminal block 16 is configured to be electrically coupled to the battery pack 15 attached to the battery holder 14. In the first embodiment, the terminal block 16 extends in the height direction.

The battery holder 14 accommodates a control unit 17 at the front of the terminal block 16. In the first embodiment, the control unit 17 extends in the height direction. The control unit 17 includes a control circuit board 18.

In the first embodiment, the motor 20 is an inner rotor type brushless motor (specifically, a three-phase brushless DC motor). In another embodiments, the motor 20 may be any other types of motors (for example, a brushed DC motor).

The motor 20 includes a stator 21. The stator 21 includes three lead wires 27 (FIG. 2 shows only one of the lead wires 27). The stator 21 includes a first insulator 23 A at its front end. The stator 21 includes a second insulator 23B at its rear end.

The stator 21 includes three coils 24 wound via the first insulator 23 A and the second insulator 23B. The second insulator 23B includes not shown six terminals fused to respective ends of wires in these coils 24.

The second insulator 23B includes a short-circuit member 25. The short-circuit member 25 includes three insert-molded short-circuit fittings 26 (FIG. 2 shows only two of the short-circuit fittings 26). These short-circuit fittings 26 electrically couple the aforementioned terminals of the second insulator 23B so that the aforementioned coils 24 form a delta configuration (or a delta connection). The aforementioned coils 24 may form a star configuration (or a star connection).

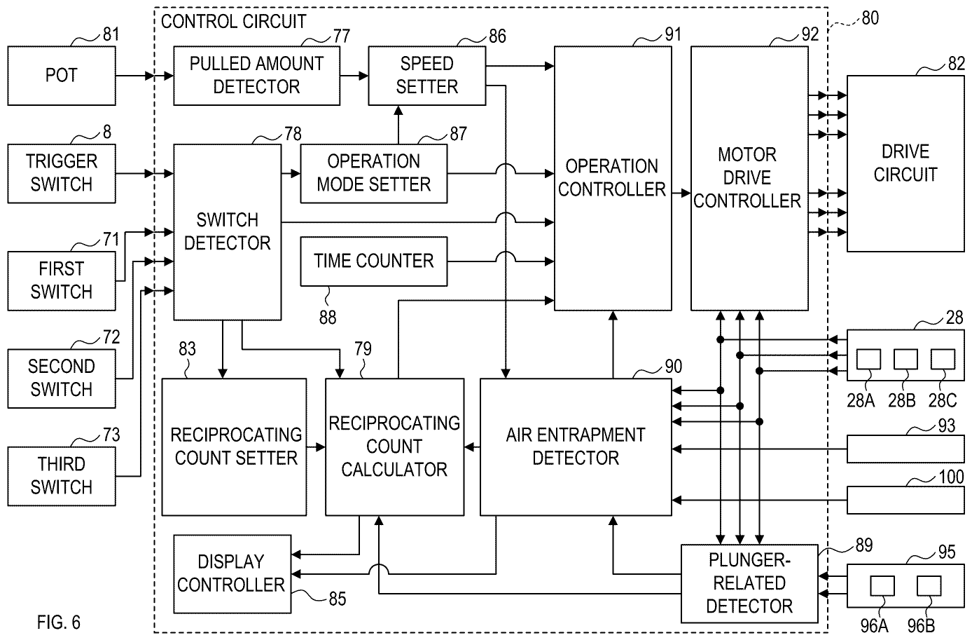

The stator 21 includes a sensor circuit board 28 between the second insulator 23B and the short-circuit member 25. The sensor circuit board 28 includes first through third rotational position sensors 28A through 28C (see FIG. 6). In the first embodiment, the first through third rotational position sensors 28A through 28C are Hall sensors, but are not limited to Hall sensors. The first through third rotational position sensors 28A through 28C are coupled to three signal lines 29 (FIG. 2 shows only one of the signal lines 29). The lead wires 27 and the signal lines 29 are coupled to the control circuit board 18 of the control unit 17.

The motor 20 includes a rotor 22 inside the stator 21. The rotor 22 includes a rotation shaft 30 at its center. The rotation shaft 30 includes two or more permanent magnets 31 embedded in an outer peripheral wall of the rotation shaft 30.

The first through third rotational position sensors 28A through 28C (i) are arranged around the rotor 22 and (ii) respectively output first through third rotation signals corresponding to a rotational position of the rotation shaft 30 (and also a rotational position of the rotor 22).

The rotation shaft 30 includes a fan 32 at its front end. In the first embodiment, the fan 32 extends perpendicular to the rotation shaft 30.

The rear joint portion 7 houses a first bearing 35 at the rear of the short-circuit member 25. The first bearing 35 rotatably supports the rear end of the rotation shaft 30.

The motor container 4 includes a gear housing 40 at the front of the electric motor 20. In the first embodiment, the gear housing 40 has a cylindrical shape. The gear housing 40 has an opening at its rear end. The gear housing 40 includes a bracket plate 41 attached to this opening. The rotation shaft 30 penetrates the bracket plate 41 and protrudes into the gear housing 40. The bracket plate 41 includes a second bearing 42. The second bearing 42 rotatably supports the front end of the rotation shaft 30.

The gear housing 40 includes a spindle 44 at its front end. The gear housing 40 houses a transmission mechanism 43. The transmission mechanism 43 is coupled to the rotation shaft 30 and transmits rotation of the rotation shaft 30 to a pump 60 described later via the spindle 44. The transmission mechanism 43 is configured (i) to receive the rotation of the rotation shaft 30 and (ii) to rotate the spindle 44 at a rotational speed lower than a rotational speed of the rotation shaft 30. In other words, the transmission mechanism 43 reduces the rotational speed of the rotation shaft 30 and transmits the reduced rotational speed to the spindle 44. The transmission mechanism 43 may include a planetary gear.

The housing 2 includes a crank housing 45 at the front end of the gear housing 40. In the first embodiment, the crank housing 45 extends in the height direction. The spindle 44 protrudes into the crank housing 45 from the gear housing 40.

The crank housing 45 houses a crank plate 46 at the front end of the spindle 44. The crank plate 46 includes an eccentric pin 47 protruding to the front.

The crank housing 45 includes a slider 48 at the front of the crank plate 46. The slider 48 has an elongated hole 48A extending in a width direction. The width direction corresponds to a direction from right to left or from left to right of the housing 2. The eccentric pin 47 is inserted into the elongated hole 48A. The slider 48 is coupled to the plunger 50 at the center of its lower end. The plunger 50 includes an upper end coupled to the slider 48 and extends downward.

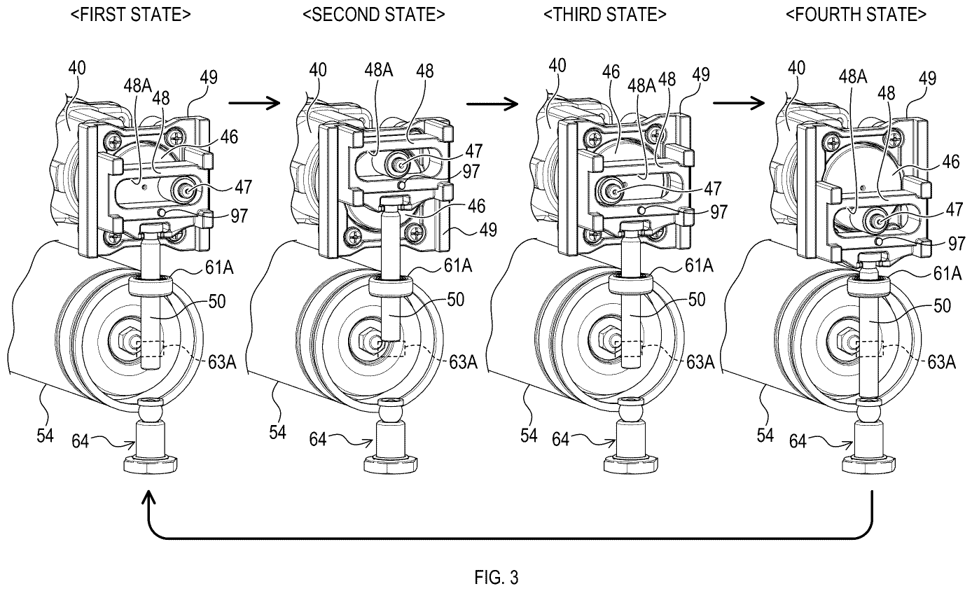

The crank housing 45 includes a slider guide 49 that supports the slider 48 so that the slider 48 can move up and down. The slider 48 and the slider guide 49 are also shown in FIG. 3. The slider 48 is movable in the height direction along the slider guide 49.

In the first embodiment, a lubricant is applied to the slider 48 and the slider guide 49 to reduce friction between the two. The lubricant is different from grease. The slider guide 49 is one example of a guide in Overview of Embodiments.

In the crank housing 45 configured as above, when the crank plate 46 rotates together with the spindle 44, the eccentric pin 47 performs eccentric movements. Due to strokes in the height direction of the eccentric pin 47, the slider 48 reciprocates integrally with the plunger 50 in first and second directions. In other words, the crank plate 46 and slider 48 convert the rotational motion of the motor 20 into linear reciprocating motion. The first direction corresponds to a downward direction, and the second direction corresponds to an upward direction. Hereinafter, the lowest position within the reciprocating range of the slider 48 and the plunger 50 (i.e., an end of the first direction) is referred to as the lower end, and the highest position within the reciprocating range (i.e., an end of the second direction) is referred to as the upper end.

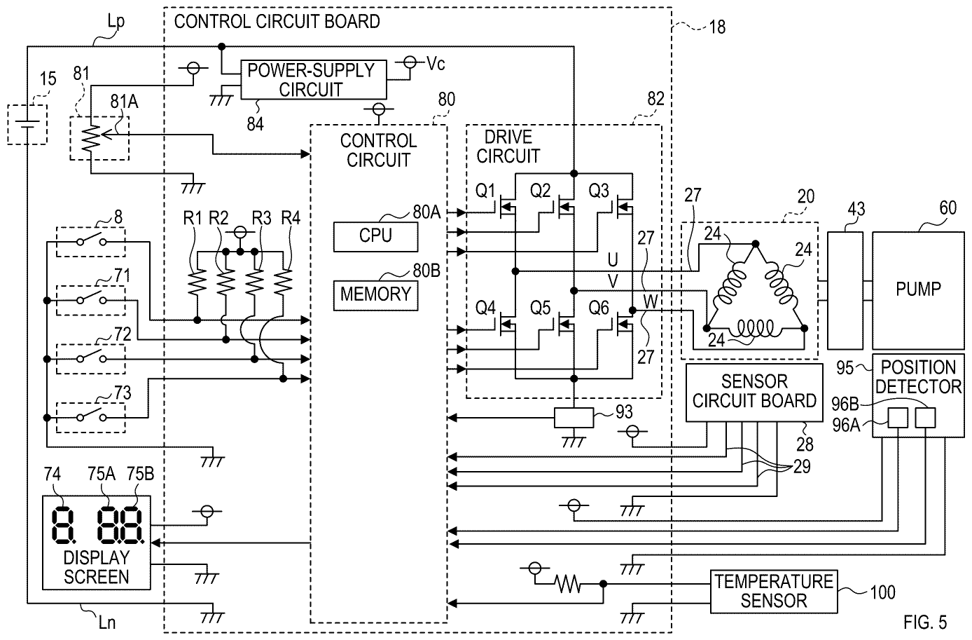

The electric-powered lubricant dispenser 1 includes a position detector 95 (see FIG. 5) at the front of the slider guide 49. The position detector 95 is configured to output first and second slider position signals corresponding to the position of the slider 48.

The position detector 95 includes a first detector 96A, a second detector 96B, and a magnet 97, as shown in FIG. 2. The magnet 97 is also shown in FIG. 3. The magnet 97 is arranged to move integrally with the slider 48. Specifically, in the first embodiment, the magnet 97 is attached to a front end face of the slider 48. The first and second detectors 96A and 96B are spaced apart a certain distance forward from the magnet 97 in a front-rear direction. In the first embodiment, each of the first and second detectors 96A and 96B includes a Hall sensor.

When the slider 48 is in the lowest position, the first detector 96A (i) faces the magnet 97 along the front-rear direction and (ii) outputs a first slider position signal. When the slider 48 is in the highest position, the second detector 96B (i) faces the magnet 97 along the front-rear direction and (ii) outputs a second slider position signal.

The crank housing 45 includes a front holder 51 at its lower part. The housing 2 includes a rear holder 52 at the rear of the front holder 51 and at a lower part of the motor container 4. The rear holder 52 includes two legs 53 protruding downward at its front and rear ends.

The electric-powered lubricant dispenser 1 includes a tank 54 supported by the front holder 51 and the rear holder 52. The tank 54 has an open front end. The tank 54 reaches to the rear surface of the front holder 51 through the rear holder 52. The front end of the tank 54 is screwed into the rear surface of the front holder 51. In other words, the tank 54 extends in the length direction below the motor container 4.

The tank 54 houses a rod 55. The rod 55 extends from the rear end of the tank 54 to the front end of the tank 54. The rod 55 holds a piston 56 in a manner movable along the rod 55. The rod 55 has a rear end protruding from the tank 54. The tank 54 includes a handle 57 attached to the rear end of the rod 55. The tank 54 houses a coil spring 58. The coil spring 58 is located at the rear of the piston 56 and biases the piston 56 to the front. The tank 54 houses a not shown cartridge filled with grease at the front of the piston 56. When this cartridge is pressed by the piston 56, grease is delivered into the front holder 51.

The front holder 51 includes a pump 60. The pump 60 includes the aforementioned plunger 50. The pump 60 includes an upper cylindrical portion 60A and a lower cylindrical portion 60B. The upper cylindrical portion 60A and the lower cylindrical portion 60B form a chamber 63. The plunger 50 is inside the chamber 63. The chamber 63 is an example of the container in Overview of Embodiments.

The chamber 63 is provided with an inflow hole 63A between the upper cylindrical portion 60A and the lower cylindrical portion 60B. The chamber 63 communicates with tank 54 via the inflow hole 63A. Grease is supplied from the cartridge into the chamber 63 through the inflow hole 63A.

The upper cylindrical portion 60A is provided with a seal ring 61A at its upper end. The plunger 50 penetrates the seal ring 61A. The seal ring 61A stops or inhibits grease in the chamber 63 from leaking upward from the upper cylindrical portion 60A.

The lower cylindrical portion 60B is provided with a dispensing path 66. The dispensing path 66 (i) communicates with the chamber 63 via a check valve 64 described later and (ii) extends in the length direction. The front holder 51 includes a front cylindrical portion 60C at its front end. The front cylindrical portion 60C protrudes to the front from the front holder 51. The dispensing path 66 passes through the center of the front cylindrical portion 60C. The dispensing path 66 has a dispensing port 66A at its front end. The front cylindrical portion 60C is coupled to a hose 68. The grease is dispensed from the dispensing port 66A to outside the electric-powered lubricant dispenser 1 via the hose 68.

The pump 60 includes the aforementioned check valve 64 at the bottom of the chamber 63. The check valve 64 permits grease to flow out from the chamber 63 to the dispensing path 66, while inhibiting or stopping grease from flowing back from the dispensing path 66 into the chamber 63.

The front cylindrical portion 60C includes a relief valve 69 at its right side portion. The relief valve 69 is configured to discharge the grease inside the dispensing path 66 to outside the electric-powered lubricant dispenser 1 in response to a pressure of the grease inside the dispensing path 66 being larger than or equal to a specified pressure.

The front holder 51 includes an air drain valve 67 at its front end. The air drain valve 67 is provided to discharge gas (e.g., air) in the chamber 63 (specifically near the inflow hole 63A) to outside the electric-powered lubricant dispenser 1. When the air drain valve 67 is tightened, the chamber 63 is sealed off from outside the electric-powered lubricant dispenser 1. The electric-powered lubricant dispenser 1 is normally used with the air drain valve 67 being tightened. When the air drain valve 67 is loosened, the chamber 63 communicates with the outside of the electric-powered lubricant dispenser 1. If gas is present in the chamber 63 at this time, the gas can be discharged to outside the electric-powered lubricant dispenser 1 via the air drain valve 67.

### 2-1-2. Mechanical Operation of Electric-Powered Lubricant Dispenser

In the electric-powered lubricant dispenser 1 configured as above, when the user pulls the trigger 9, the motor 20 rotates, and then the rotation shaft 30 rotates.

Rotation of the rotation shaft 30 is transmitted to the spindle 44 via the transmission mechanism 43, and the crank plate 46 rotates together with the spindle 44. This causes the eccentric pin 47 to perform eccentric movements. In response to the eccentric movements of the eccentric pin 47, (i) the slider 48 moves up and down along the slider guide 49 in its reciprocating range (in other words, its travel path), and (ii) as a result, the plunger 50 reciprocates up and down integrally with the slider 48 (i.e., in the first and second directions). The slider 48 and plunger 50 are examples of the reciprocating members in Overview of Embodiments.

More specifically, as shown in FIG. 3, the plunger 50 moves up and down (specifically, completes one reciprocation) through first to fourth states in this order. FIG. 3 schematically shows the position of the inflow hole 63A.

The first state is a state in which the slider 48 is moving in the second direction. More specifically, the first state is the state where the slider 48 is in an intermediate position within the reciprocating range. FIG. 2 shows the electric-powered lubricant dispenser 1 in the first state. In the first state, as evident from FIG. 2, the plunger 50 is inserted into the lower cylindrical portion 60B. When the motor 20 rotates further from the first state, the slider 48 and the plunger 50 move in the second direction, and the electric-powered lubricant dispenser 1 transitions to the second state.

The second state is when the slider 48 reaches its uppermost position. Before the slider 48 reaches the uppermost position, a lower end of the plunger 50 exits the lower cylindrical portion 60B, thereby allowing grease to flow from the tank 54 into the chamber 63. In the second state, the lower end of the plunger 50 is either fully contained in the upper cylindrical portion 60A or protrudes slightly downward from the upper cylindrical portion 60A. In the second state, a second slider position signal is output from the second detector 96B. When the motor 20 rotates further from the second state, the slider 48 moves in the first direction, and the electric-powered lubricant dispenser 1 transitions to the third state.

The third state is a state where the slider 48 is moving in the first direction. Specifically, the third state is when the slider 48 is in an intermediate position in the reciprocating range. In the third state, similar to the first state, the plunger 50 is inserted into the lower cylindrical portion 60B. When the motor 20 rotates further from the third state, the electric-powered lubricant dispenser 1 transitions to the fourth state.

The fourth state is a state when the slider 48 reaches the lowest position. In the fourth state, the lower end of the plunger 50 reaches near the bottom of the chamber 63. In the fourth state, the first slider position signal is output from the first detector 96A. When the motor 20 rotates further from the fourth state, the slider 48 moves in the second direction, and the electric-powered lubricant dispenser 1 transitions to the first state.

During a period from the second state to the fourth state, the plunger 50 moves in the first direction. During this time, the grease in the chamber 63 is pressed against the bottom surface of the plunger 50. Consequently, the grease flows into the hose 68 via the check valve 64, the dispensing path 66, and dispensing port 66A, and is dispensed from the hose 68 to outside the electric-powered lubricant dispenser 1.

As above, while the motor 20 rotates, reciprocation of the slider 48 (and consequently reciprocation of the plunger 50) is repeated, causing grease to be continuously dispensed (or able to be dispensed) from the dispensing port 66A. Each time the plunger 50 completes one reciprocation, grease is dispensed. Therefore, one reciprocation of the plunger 50 can be said to be one dispensing operation of grease.

The motor 20 may rotate in an opposite direction to that of the operation example shown in FIG. 3. In this case, the plunger 50 moves up and down, passing through the fourth through first states in this order, thereby dispensing grease in the same manner as the operation example in FIG. 3.

### 2-1-3. Detail of Operation Panel

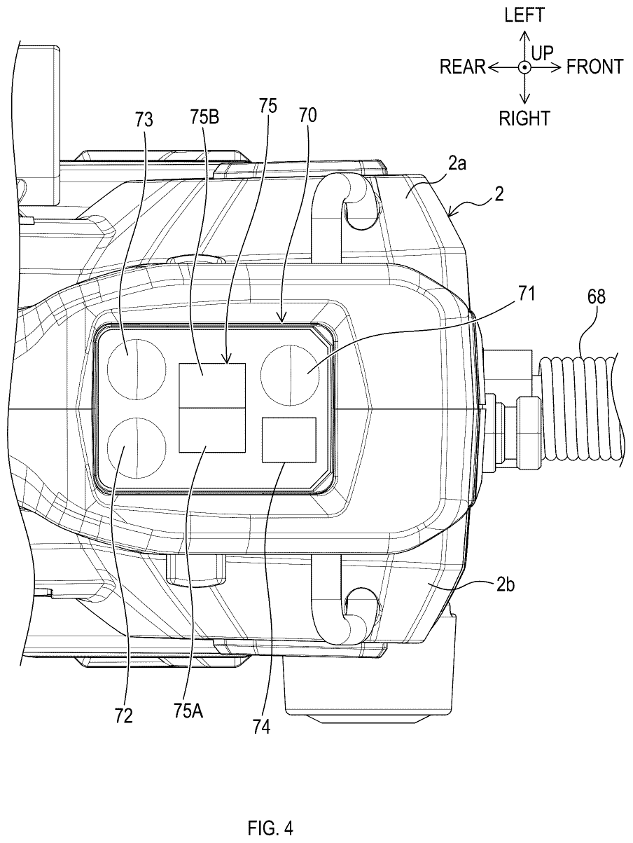

As shown in FIG. 4, the operation panel 70 includes a first switch 71. In the first embodiment, the first switch 71 and second and third switches 72 and 73 described later are pushbutton switches. In another embodiment, the first through third switches 71 through 73 may be other types of manual switches.

Each time the first switch 71 is short pressed, a level of the rotational speed of the motor 20 is sequentially switched (i.e., set) to one of rotational speed ranges (or rotational speed levels). The rotational speed ranges include, for example, first through fourth speed ranges. For each rotational speed range, a maximum rotational speed of the motor 20 is set. The maximum rotational speed increases in the order of, for example, first speed range, second speed range, third speed range, and fourth speed range.

The motor 20 is rotated up to the maximum rotational speed corresponding to the set rotational speed range. Specifically, for example, a desired rotational speed is set depending on an operation mode described later and/or a pulled amount (i.e., position) of the trigger 9, with the set maximum rotational speed as its upper limit. The motor 20 is controlled to maintain a constant rotational speed (in other words, speed feedback controlled) such that its actual rotational speed is consistent with the desired rotational speed.

When the first switch 71 is long pressed, the light 10 turns on. After being turned on, the light 10 may be turned off, for example, when (i) a specified time has elapsed or (ii) the first switch 71 is long pressed again. A short press corresponds to an operation in which the pressing operation is released before a given period of time has elapsed since the pressing begins. A long press corresponds to an operation in which the pressing operation is released after the pressing has been continued for a given period of time or longer.

The operation panel 70 includes a first display screen 74. The first display screen 74 displays information indicating the set rotational speed range (e.g., a numerical value from “1” through “4”). The values “1” through “4” respectively indicate the first to fourth speed ranges. In the first embodiment, the first display screen 74 and second and third display screens 75A and 75B described later are each a seven-segment display. In another embodiment, each of the first through third display screens 74, 75A, and 75B may be other types of display screens including a liquid crystal display (LCD).

The operation panel 70 includes the aforementioned second switch 72 and third switch 73. Each time the second and third switches 72, 73 are pressed simultaneously, the operation mode of the electric-powered lubricant dispenser 1 switches. In the first embodiment, the operation modes include a continuous dispensing mode and an automatic dispensing mode (or a fixed-volume dispensing mode). In the first embodiment, each time the second and third switches 72 and 73 are pressed simultaneously, the operation mode alternately switches between the continuous dispensing mode and the automatic dispensing mode.

In the continuous dispensing mode, the motor 20 continuously rotates while the trigger 9 is pulled. In the first embodiment, the desired rotational speed in the continuous dispensing mode changes depending on the position of the trigger 9. Specifically, the desired rotational speed increases continuously or in steps as the trigger 9 moves from the minimum position to a desired arrival position. More specifically, the desired rotational speed increases from a specified minimum value (e.g., zero) toward the maximum rotational speed corresponding to the set rotational speed range. The desired arrival position may exist between the minimum position and the maximum position, or may coincide with the maximum position. When the trigger 9 reaches the desired arrival position, the desired rotational speed reaches the maximum rotational speed corresponding to the set rotational speed range. When the trigger 9 exists between the desired arrival position and the maximum position, the desired rotational speed is maintained at the maximum rotational speed.

In the continuous dispensing mode, the desired rotational speed may be maintained at a fixed rotational speed (e.g., the maximum rotational speed corresponding to the set rotational speed range) regardless of the position of the trigger 9.

In automatic dispensing mode, rotation of the motor 20 begins in response to the trigger 9 being pulled. After the rotation begins, once the plunger 50 (in other words, the slider 48) has completed a desired reciprocating count, the motor 20 automatically stops, even if the trigger 9 is still being pulled. The plunger completing the desired reciprocating count corresponds to (i) the specified dispensing operation being performed the desired number of times, and/or (ii) an amount of grease corresponding to the desired reciprocating count being dispensed. The desired reciprocating count can be set to any value by the user.

In the automatic dispensing mode, the desired rotational speed is set to a constant rotational speed (e.g., the maximum rotational speed corresponding to the set rotational speed range), regardless of the position of the trigger 9. However, the desired rotational speed in the automatic dispensing mode may change depending on the position of the trigger 9, as in the continuous dispensing mode.

The operation panel 70 includes a set count display screen 75. The set count display screen 75 (i) includes the aforementioned second display screen 75A and the third display screen 75B, and (ii) can display two-digit numbers. When the operation mode is set to the automatic dispensing mode, the desired reciprocating count is displayed on the set count display screen 75.

In the first embodiment, in the automatic dispensing mode, any desired reciprocating count can be set, with a maximum set count serving as an upper limit. The maximum set count may be a specified value, for example, 99 or less. The user can set the desired reciprocating count to any value by operating the second switch 72 or the third switch 73. Specifically, in the automatic dispensing mode, each time the second switch 72 is pressed, (i) the desired reciprocating count increases by one, and (ii) the newly increased desired reciprocating count is displayed on the set count display screen 75. Conversely, in the automatic dispensing mode, each time the third switch 73 is pressed, (i) the desired reciprocating count decreases by one, and (ii) the decreased new desired reciprocating count is displayed on the set count display screen 75. The maximum set count may be determined in any manner, and may be, for example, a specified value of 99 or less, or a specified value of 100 or more.

### 2-1-4. Electrical Configuration of Electric-Powered Lubricant Dispenser

Referring to FIG. 5, the electrical configuration of the electric-powered lubricant dispenser 1 is described. The electric-powered lubricant dispenser 1 includes a control circuit board 18. The control circuit board 18 includes a ground. The electric-powered lubricant dispenser 1 includes a power supply line Lp. The power supply line Lp extends from a positive electrode connection terminal (not shown) onto the control circuit board 18. The positive electrode connection terminal is coupled to a positive electrode of the battery pack 15 while the battery pack 15 is attached to the battery holder 14. The electric-powered lubricant dispenser 1 includes a ground line Ln. The ground line Ln extends from a negative electrode connection terminal (not shown) to the ground on the control circuit board 18. The negative electrode connection terminal is coupled to a negative electrode of the battery pack 15 while the battery pack 15 is attached to the battery holder 14. The battery pack 15 applies its rated voltage between the power supply line Lp and the ground line Ln.

The electric-powered lubricant dispenser 1 includes a power-supply circuit 84. In the first embodiment, the power-supply circuit 84 is on the control circuit board 18. The power-supply circuit 84 is coupled to the power supply line Lp and the ground. The power-supply circuit 84 generates a fixed DC voltage (hereinafter, referred to as “power-supply voltage”) Vc based on the battery voltage supplied from the battery pack 15.

The electric-powered lubricant dispenser 1 includes a control circuit 80. The control circuit 80 is disposed on the control circuit board 18, and operates with the power-supply voltage Vc. The control circuit 80 is a microcomputer including a CPU (or a processor) 80A, and a semiconductor memory 80B. The semiconductor memory 80B includes a ROM, a RAM, and a rewritable non-volatile memory. Examples of the rewritable non-volatile memory include an EEPROM, a flash memory, a ReRAM, and a FeRAM. Various functions of the control circuit 80 are achieved by the CPU 80A executing a program stored in the semiconductor memory 80B. As a result of the CPU 80A executing the program, a method corresponding to this program is performed.

In another embodiment, the control circuit 80 may include an additional microcomputer. In further another embodiment, part or all of the functions achieved by the CPU 80A may be achieved by one or more electronic components (for example, an integrated circuit). In further another embodiment, the control circuit 80 may be a logic circuit (or a wired logic connection) including two or more electronic components. In further another embodiment, the control circuit 80 may include an ASIC and/or an ASSP. In further another embodiment, the control circuit 80 may include a programmable logic device in which a reconfigurable logic circuit(s) can be built. Examples of the programmable logic device include an FPGA.

The electric-powered lubricant dispenser 1 includes a drive circuit 82. The drive circuit 82 is configured to supply electric current (hereinafter referred to as “motor current”) to the motor 20 to drive the motor 20. The drive circuit 82 is electrically coupled to the power supply line Lp and the ground line Ln. The drive circuit 82 (i) receives the battery voltage, (ii) generates a three-phase voltage (i.e., generates three-phase power) from that battery voltage, and (iii) supplies that three-phase voltage to the motor 20. In the first embodiment, the drive circuit 82 is disposed on the control circuit board 18.

The drive circuit 82 is a three-phase full-bridge circuit, but is not limited to a three-phase full-bridge circuit. The drive circuit 82 includes first through third switches Q1 through Q3 arranged on a high side and fourth through sixth switches Q4 through Q6 arranged on a low side. Each of the first through third switches Q1 through Q3 is coupled to the power supply line Lp and a corresponding lead wire 27, functioning as so-called high-side switches. Each of the fourth through sixth switches Q4 through Q6 is coupled to a corresponding lead wire 27 and to the ground, functioning as so-called low-side switches.

The first through sixth switches Q1 through Q6 respectively receive first through sixth drive control signals from the control circuit 80. Each of the first through sixth switches Q1 through Q6 turns on or off in accordance with the corresponding drive control signal received. In the first embodiment, each of first through sixth drive control signals may be a pulse width modulated signal. In the first embodiment, each of the first through sixth switches Q1 through Q6 is a semiconductor switch. Examples of the semiconductor switch include a field-effect transistor (FET), a bipolar transistor, and an insulated-gate bipolar transistor (IGBT).

When the motor 20 is driven, basically one high-side switch (i.e., one of switches Q1 through Q3) and one low-side switch (i.e., one of switches Q4 through Q6) are turned on. This allows the motor current to flow from the positive electrode of the battery, through the high-side switch, the motor 20, and the low-side switch, to the negative electrode of the battery, thereby rotating the motor 20.

The electric-powered lubricant dispenser 1 includes a current detector 93. The current detector 93 is disposed on a current path coupling the drive circuit 82 to the negative electrode of the battery. The current detector 93 outputs a current detection signal corresponding to a magnitude of the motor current flowing through this current path to the control circuit 80.

The electric-powered lubricant dispenser 1 includes a potentiometer 81 having a lever 81A. The lever 81A has a displaceable first end and a second end coupled to the control circuit 80. The potentiometer 81 has a resistance value that changes depending on a position of the first end of the lever 81A. The second end of the lever 81A outputs a voltage (hereinafter referred to as “trigger voltage”) having a magnitude corresponding to the resistance value to the control circuit 80. The first end of the lever 81A is displaced in accordance with the position of the trigger 9 within the range from the initial position to the maximum position. For example, the resistance value of the potentiometer 81 is minimum when the trigger 9 is in the initial position and increases as the trigger 9 approaches the maximum position from the initial position.

The electric-powered lubricant dispenser 1 includes first through fourth pull-up resistors R1 through R4. In the first embodiment, the first through fourth pull-up resistors R1 through R4 are on the control circuit board 18. Each of the first through fourth pull-up resistors R1 through R4 has a first end coupled to the power-supply circuit 84 so as to receive the power-supply voltage Vc from the power-supply circuit 84. The first pull-up resistor R1 has a second end coupled to the first end of the trigger switch 8 and the control circuit 80. The second pull-up resistor R2 has a second end coupled to a first end of the first switch 71 and the control circuit 80. The third pull-up resistor R3 has a second end coupled to a first end of the second switch 72 and the control circuit 80. The fourth pull-up resistor R4 has a second end coupled to a first end of the third switch 73 and the control circuit 80. The trigger switch 8, the first switch 71, the second switch 72, and the third switch 73 each have a second end coupled to the ground on the control circuit board 18.

When the trigger switch 8, the first switch 71, the second switch 72, and the third switch 73 are off, the second ends of the first through the fourth pull-up resistors R1 through R4 have a voltage level equal to the power-supply voltage Vc (i.e., a high level). When the trigger switch 8, the first switch 71, the second switch 72, and the third switch 73 are on, the second ends of the first through fourth pull-up resistors R1 through R4 have a voltage at the same level as the ground (i.e., a low level). The first through fourth pull-up resistors R1 through R4 may have the same resistance value or may have different resistance values.

The control circuit 80 can detect whether the trigger 9, the first switch 71, the second switch 72, and the third switch 73 are manually operated based on the voltages at the second ends of the first through fourth pull-up resistors R1 through R4. Specifically, when the voltages at the second ends of the first through fourth pull-up resistors R1 through R4 are high, the control circuit 80 detects that the trigger 9, the first switch 71, the second switch 72, and the third switch 73 are not manually operated. If the voltages at the second end of the first through fourth pull-up resistors R1 through R4 are low, the control circuit 80 detects that the trigger 9, the first switch 71, the second switch 72, and the third switch 73 are manually operated.

The control circuit board 18 is coupled to the first through third display screens 74, 75A, and 75B of the operation panel 70. The first through third display screens 74, 75A, and 75B operate by receiving the power-supply voltage Vc from the control circuit board 18. Furthermore, the first through third display screens 74, 75A, 75B each receive first through third display control signals from the control circuit 80 and display the information.

The control circuit board 18 is coupled to the sensor circuit board 28. The first through third rotational position sensors 28A through 28C on the sensor circuit board 28 operate by receiving the power-supply voltage Vc from the control circuit board 18. The first through third rotational position sensors 28A through 28C are coupled to the control circuit 80 via the signal lines 29 and output first through third rotation signals to the control circuit 80. The first through third rotation signals are associated with respective three phases (namely, the U phase, V phase, and W phase) of the motor 20. The first through third rotation signals have a phase difference of 120 electrical degrees relative to each other. The first through third rotation signals may be, for example, sine wave signals. In this case, a voltage of each of the first through third rotation signals reverses from positive to negative or from negative to positive every time the rotor 22 rotates 180 electrical degrees. The first through third rotation signals may, for example, be square wave signals. In this case, a logic value of each of the first through third rotation signals reverses every time the rotor 22 rotates 180 electrical degrees.

In another embodiment, the sensor circuit board 28 may be configured to output a single rotation detection signal (e.g., a pulse signal) to the control circuit 80 instead of the first through third rotation signals. The rotation detection signal changes each time the rotor 22 rotates 60 electrical degrees.

The electric-powered lubricant dispenser 1 includes a temperature sensor 100 coupled to the control circuit 80. The temperature sensor 100 is provided to detect the temperature of the electric-powered lubricant dispenser 1. More specifically, the temperature sensor 100 is provided to directly or indirectly detect the temperature of the grease. The temperature sensor 100 outputs a temperature detection signal indicating the detected temperature to the control circuit 80. The temperature sensor 100 may be in any form capable of detecting the temperature. The temperature sensor 100 may, for example, include a positive temperature coefficient (PTC) thermistor, a negative temperature coefficient (NTC) thermistor, or a critical temperature resistor (CTR) thermistor.

The temperature sensor 100 may be positioned to directly or indirectly detect the temperature (or the level) of the grease. For example, the temperature sensor 100 may be disposed in a position where the temperature sensor 100 can come into direct contact with the grease. More specifically, the temperature sensor 100 may be disposed, for example, at an inlet (e.g., inflow port 63A) of the pump 60.

Alternatively, the temperature sensor 100 may be disposed in a position not in contact with the grease. Specifically, the temperature sensor 100 may be disposed, for example, on a surface or inside of the grip 5, around the front holder 51, or near the tank 54 in the housing 2.

The control circuit board 18 is coupled to the position detector 95. The first and second detectors 96A and 96B in the position detector 95 operate by receiving the power-supply voltage Vc from the control circuit board 18. The first and second detectors 96A and 96B output the first and second slider position signals to the control circuit 80.

The position detector 95 is basically used in fourth through sixth embodiments described later and not used in the first embodiment or second and third embodiments described later. Therefore, the position detector 95 may be omitted in the first through third embodiments. However, even in the first through third embodiments, various processes may be performed based on the first and second slider position signals from the position detector 95.

### 2-1-5. Functional Configuration of Electric-Powered Lubricant Dispenser

Referring to FIG. 6, functions of the control circuit 80 will be described. The control circuit 80 includes functions of a pulled amount detector 77, a switch detector 78, a reciprocating count setter 83, a reciprocating count calculator 79, a display controller 85, a speed setter 86, an operation mode setter 87, a time counter (or timer) 88, a plunger-related detector 89, an air entrapment detector 90, an operation controller 91, and a motor drive controller 92. In the first embodiment, these functions are incorporated into the control circuit 80 by software. That is, these functions are achieved by the CPU 80A executing corresponding programs (specifically, a main process described later).

In another embodiment, at least any one of the functions of the pulled amount detector 77, the switch detector 78, the reciprocating count setter 83, the reciprocating count calculator 79, the display controller 85, the speed setter 86, the operation mode setter 87, the time counter 88, the plunger-related detector 89, the air entrapment detector 90, the operation controller 91, and motor drive controller 92 may be incorporated into the control circuit 80 by hardware (electronic circuit), not by software. In another embodiment, at least any one of the functions of the pulled amount detector 77, the switch detector 78, the reciprocating count setter 83, the reciprocating count calculator 79, the display controller 85, the speed setter 86, the operation mode setter 87, the time counter 88, the plunger-related detector 89, the air entrapment detector 90, the operation controller 91, and the motor drive controller 92 may be removed.

The pulled amount detector 77 receives the trigger voltage from the potentiometer 81. The pulled amount detector 77 detects an actual pulled amount of the trigger 9 based on the trigger voltage. The actual pulled amount is an actual distance the trigger 9 has been pulled (i.e., actual position of the trigger 9). The pulled amount detector 77 detects the actual pulled amount of zero when the magnitude of the trigger voltage corresponds to the initial position of the trigger 9. The pulled amount detector 77 detects a maximum actual pulled amount when the magnitude of the trigger voltage corresponds to the maximum position of the trigger 9. The pulled amount detector 77 detects the actual pulled amount between zero and the maximum value when the magnitude of the trigger voltage corresponds to the intermediate position of the trigger 9. The intermediate position is between the initial position and the maximum position. The pulled amount detector 77 outputs the detected actual pulled amount to the speed setter 86.

The switch detector 78 detects changes from off to on and from on to off of each of the trigger switch 8, the first switch 71, the second switch 72, and the third switch 73. The switch detector 78 outputs a first signal to the operation controller 91 and the reciprocating count calculator 79 in response to the trigger switch 8 changing from off to on. The first signal indicates that the trigger switch 8 has changed from off to on. The switch detector 78 outputs a second signal to the operation controller 91 and the reciprocating count calculator 79 in response to the trigger switch 8 changing from on to off. The second signal indicates that the trigger switch 8 has changed from on to off. The switch detector 78 outputs a third signal to the operation mode setter 87 in response to the first switch 71 changing from off to on. The third signal indicates that the first switch 71 has changed from off to on. The switch detector 78 outputs a fourth signal to the operation mode setter 87 in response to simultaneous on of the second switch 72 and the third switch 73. The simultaneous on means changing from off to on simultaneously or nearly simultaneously. The fourth signal indicates that the second switch 72 and the third switch 73 have simultaneously turned on.

The switch detector 78 outputs a fifth signal to the reciprocating count setter 83 in response to the second switch 72 changing from off to on while the third switch 73 is off. The fifth signal indicates that the second switch 72 has changed from off to on. While the second switch 72 is off, the switch detector 78 outputs a sixth signal to the reciprocating count setter 83 in response to the third switch 73 changing from off to on. The sixth signal indicates that the third switch 73 has changed from off to on.

The operation mode setter 87 sets the rotational speed range of the motor 20 in response to the input third signal. Specifically, each time the third signal is input, the operation mode setter 87 changes the rotational speed range in the following order: the first speed range, the second speed range, the third speed range, the fourth speed range, the first speed range, . . . .

The operation mode setter 87 sets the operation mode of the electric-powered lubricant dispenser 1 to either the continuous dispensing mode or the automatic dispensing mode in response to the input of the fourth signal. Specifically, the operation mode setter 87 alternately switches the operation mode between the continuous dispensing mode and the automatic dispensing mode each time the fourth signal is input.

The operation mode setter 87 outputs the set operation mode to the speed setter 86, the reciprocating count setter 83, the reciprocating count calculator 79, and the operation controller 91. In FIG. 6, arrows from the operation mode setter 87 to the reciprocating count setter 83 and the reciprocating count calculator 79 are omitted. The operation mode setter 87 outputs the set rotational speed range to the speed setter 86 and the display controller 85. In FIG. 6, an arrow from the operation mode setter 87 to the display controller 85 is omitted.

The speed setter 86 sets the desired rotational speed of the motor 20 based on the input actual pulled amount, rotational speed range, and operation mode. The speed setter 86 notifies the operation controller 91 and the air entrapment detector 90 of the set desired rotational speed. The rotational speed of the motor 20 is proportional to a dispensing speed. The dispensing speed is a speed at which the grease is dispensed from the dispensing port 66A, or in other words, the amount of grease dispensed per unit time. Therefore, setting the desired rotational speed is equivalent to setting the desired value of the dispensing speed.

Specifically, when the operation mode is set to the continuous dispensing mode, the speed setter 86 sets the desired rotational speed to a value corresponding to the actual pulled amount within a settable range. The settable range extends from a minimum value (e.g., zero) to a maximum rotational speed corresponding to the rotational speed range. On the other hand, when the operation mode is set to the automatic dispensing mode, the speed setter 86 maintains the desired rotational speed at a constant speed (e.g., the maximum rotational speed corresponding to the rotational speed range).

In the first embodiment, at startup of the motor 20, the desired rotational speed is not immediately set to a specified set value. The desired rotational speed gradually increases toward the specified set value after the startup of the motor 20. The specified set value is the desired rotational speed corresponding to the position of the trigger 9 in the continuous dispensing mode, and the aforementioned constant desired rotational speed in the automatic dispensing mode. However, the desired rotational speed may be set immediately to the specified set value at the startup of the motor 20.

The reciprocating count setter 83 sets the desired reciprocating count of the plunger 50 (in other words, the desired number of dispensing operations) based on the input fifth signal and sixth signal when the operation mode is set to the automatic dispensing mode. Specifically, each time the reciprocating count setter 83 receives the fifth signal, the desired reciprocating count is increased by one from the current value. The reciprocating count setter 83 decreases the desired reciprocating count by one from the current value each time the sixth signal is received. The latest desired reciprocating count may be maintained (i.e., stored) at all times. Alternatively, the desired reciprocating count may be set to an initial value (e.g., zero) each time the battery pack 15 is attached to the electric-powered lubricant dispenser 1 (i.e., each time the control circuit 80 is activated). In the first embodiment, the desired reciprocating count is set to one of, for example, 0 to 99. The reciprocating count setter 83 outputs the set desired reciprocating count to the reciprocating count calculator 79.

The plunger-related detector 89 receives the first through third rotation signals from the first through third rotation position sensors 28A through 28C. The plunger-related detector 89 counts the number of rotations of the motor 20 based on the first through third rotation signals. The plunger-related detector 89 determines whether the plunger 50 has completed one reciprocation (i.e., whether one dispensing operation has been performed) based on the number of rotations of the motor 20 and a reduction ratio of the transmission mechanism 43. Each time the plunger-related detector 89 determines that the plunger 50 has completed one reciprocation (i.e., one dispensing operation has been performed), a reciprocation determination signal is output to the reciprocating count calculator 79 and the air entrapment detector 90.

The plunger-related detector 89 may receive the first and second slider position signals from the position detector 95 instead of or in addition to the first through third rotation signals. The plunger-related detector 89 may determine whether the plunger 50 has completed one reciprocation based on the first and second slider position signals. For example, the plunger-related detector 89 may determine that the plunger 50 has completed one reciprocation each time the first slider position signal is received or each time the second slider position signal is received, and output the reciprocation determination signal.

The air entrapment detector 90 detects air entrapment (or gas entrapment) when the operation mode is set to the automatic dispensing mode. However, the air entrapment detector 90 may also detect air entrapment when the operation mode is set to the continuous dispensing mode. Due to various factors, gas (e.g., air or its bubbles) may be introduced into the chamber 63. Gas may be introduced, for example, during attachment or removal of the cartridge. Alternatively, gas may be present with the grease inside the cartridge from the outset.

When entering the chamber 63, gas repeatedly expands and compresses as the plunger 50 reciprocates. Consequently, during a downward movement of the plunger 50, the check valve 64 may fail to open (or may be difficult to open), potentially stopping the grease from being dispensed (or making the grease difficult to be dispensed). Air entrapment refers to (i) a situation as such, and/or (ii) gas being present in the chamber 63 itself, and/or (iii) a state in which the pump 60 is attempting to discharge that gas.

The air entrapment detector 90 notifies the reciprocating count calculator 79, the display controller 85, the time counter 88, and the operation controller 91 of a detection result of the air entrapment. Specifically, the air entrapment detector 90 determines whether air entrapment has occurred each time the plunger 50 completes one reciprocation. If it is determined that no air entrapment has occurred, an air entrapment detection state is set to “Not Detected.” If it is detected that air entrapment has occurred, the air entrapment detection state is set to “Detected.” The reciprocating count calculator 79, the display controller 85, the time counter 88, and the operation controller 91 can determine whether air entrapment has occurred based on the set air entrapment detection state.

Hereinafter, an air entrapment detection function by the air entrapment detector 90 will be described. Before proceeding with this description, the terms “motor load” and “specific load” will be defined.

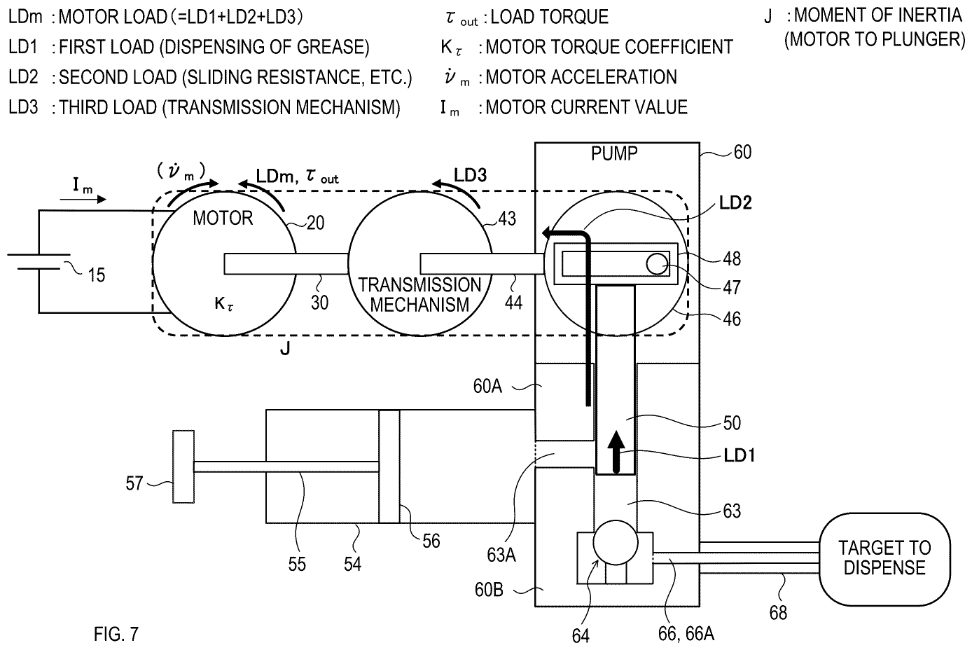

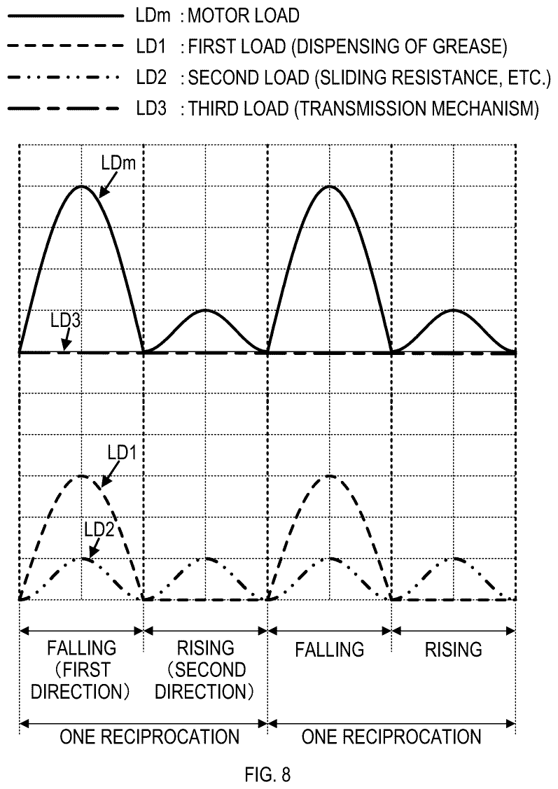

“Motor load” refers to the load externally applied to the motor 20. As schematically shown in FIGS. 7 and 8, the motor load includes a first load, a second load, and a third load. In the first embodiment, the motor load is the sum of the first through third loads.

The first load and second load are loads generated by the pump 60.

The first load is a load generated by the plunger 50 receiving a pressure from the grease and applied to the motor 20.

The second load is a load generated by reciprocation of the slider 48 and/or the plunger 50 itself, independent of the aforementioned pressure, and applied to the motor 20. The second load is primarily generated due to sliding resistance (i.e., friction) between the slider 48 and the slider guide 49. This sliding resistance is influenced by the aforementioned lubricant. Viscosity of the lubricant changes with its temperature. Therefore, the sliding resistance changes depending on the temperature of the lubricant. In other words, the second load changes depending on the temperature of the lubricant. The second load may also be generated from sliding resistance between the plunger 50 and the inner peripheral surface of the chamber 63.

On the other hand, the third load is a load generated from sources other than the pump 60. In the first embodiment, the third load is generated due to mechanical losses (e.g., gear friction) in the transmission mechanism 43.

As shown in FIG. 8, the first load increases significantly when the plunger 50 is moving in the first direction (i.e., during the dispensing of grease) and is very small or zero when the plunger 50 is moving in the second direction. FIG. 8 shows an example in which the first load is zero during movement in the second direction for simplicity of explanation. The fluctuation in the first load repeats each time the plunger 50 completes one reciprocation. In other words, the first load fluctuates approximately periodically, with one reciprocation of the plunger 50 forming one cycle.

On the other hand, as shown in FIG. 8, the second load repeats a substantially similar fluctuation each time the slider 48 moves one way. “One way” means from the first end to the second end and from the second end to the first end within the reciprocating range. That is, the second load fluctuates approximately periodically, with one one-way movement of the slider 48 (i.e., one one-way movement of the plunger 50) forming one cycle.

The third load remains constant or nearly constant for at least the typical continuous dispensing time (e.g., several seconds to several tens of seconds, or in some cases, several minutes). Only as one example, in two reciprocation periods shown in FIG. 8, the third load is constant.

The “specific load” is part of the motor load. The specific load includes the first load and does not include at least part of the second load. In the first embodiment, the specific load further includes the third load.

In the first embodiment, the specific load does not include a major part of the second load or does not include the second load at all. The specific load can be said to be the motor load with part or all of the second load removed. FIG. 8 shows an example in which the third load is larger than the first and second loads. If the third load is significantly smaller than the first and second loads, the specific load can be considered to be the first load plus part of the second load, or equal to the first load.

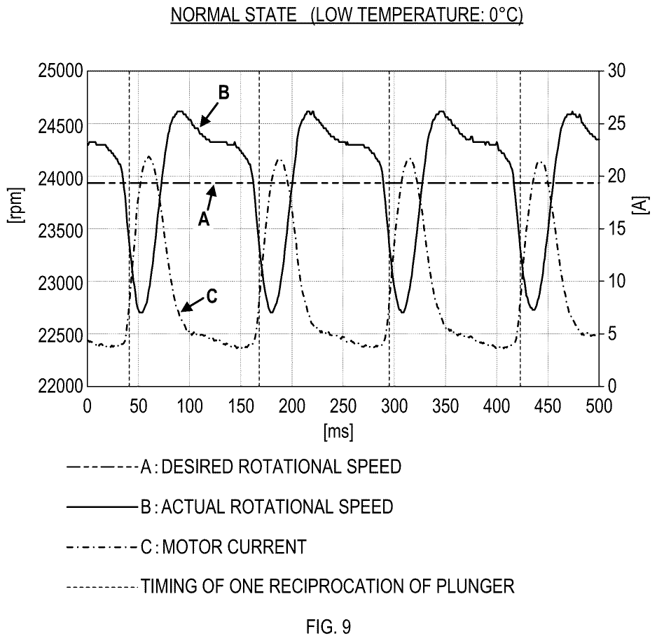

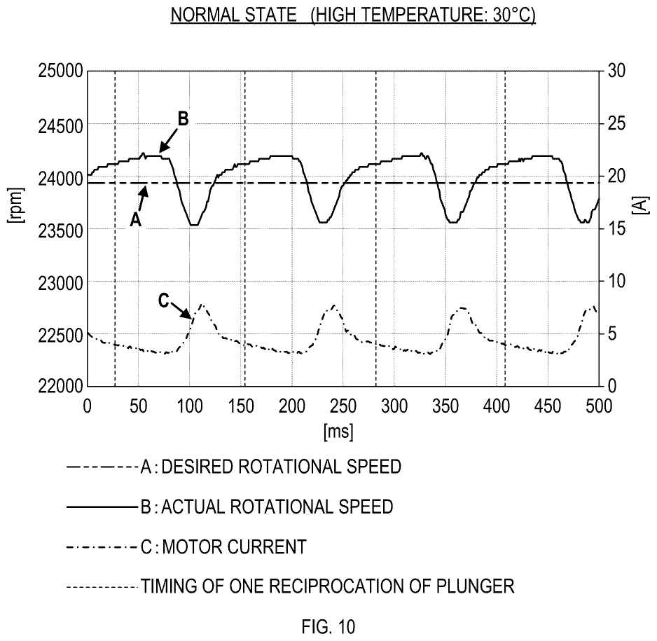

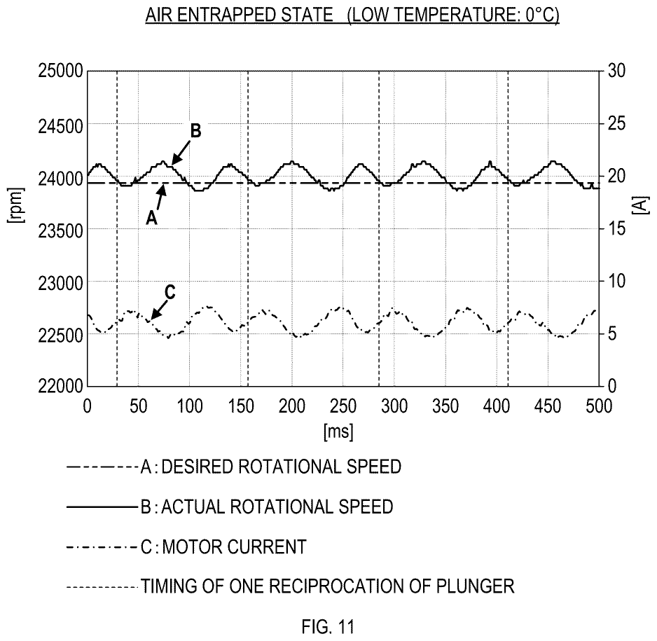

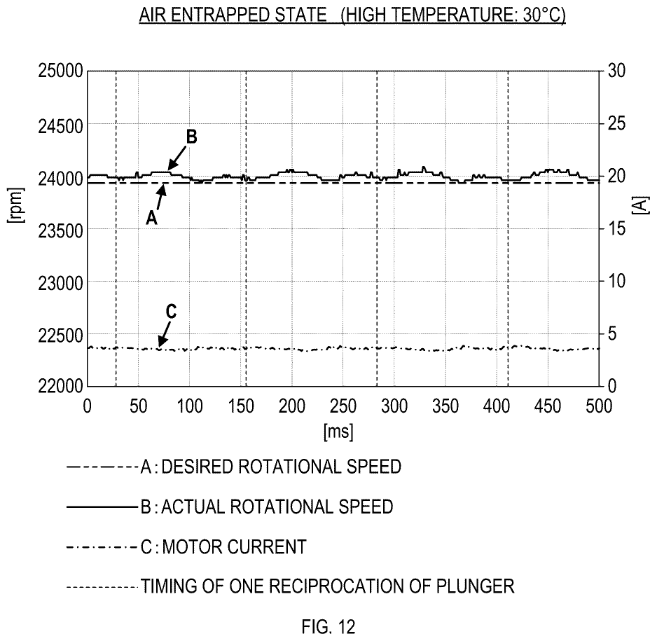

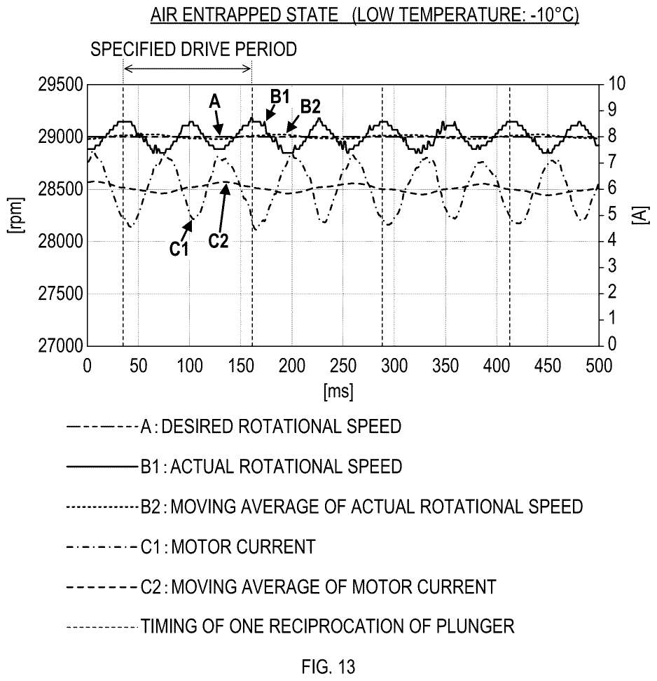

Air entrapment can be detected based on, for example, the actual rotational speed itself or the value of the motor current (hereinafter referred to as the “motor current value”) itself. As evident from comparison between FIGS. 9 and 11 or between FIGS. 10 and 12, (i) the fluctuation in the actual rotational speed in an air entrapped state (or gas entrapped state) is smaller than the fluctuation in the actual rotational speed in a normal state, and (ii) fluctuation in the motor current value in the air entrapped state is smaller than fluctuation in the motor current value in the normal state. The normal state refers to a state in which no air entrapment has occurred, while the air entrapped state refers to a state in which air entrapment has occurred. Therefore, it is possible to detect occurrence of air entrapment based on a magnitude of the fluctuation in the actual rotational speed or a magnitude of the fluctuation in the motor current value. Note that each “timing of one reciprocation of the plunger” in FIGS. 9 through 12 is a timing when the plunger 50 has reached a specified position (e.g., the uppermost position) in that reciprocation. The same applies to “timing of one reciprocation of the plunger” in FIGS. 13, 14, 23, and 24.

However, the actual rotational speed and the motor current value contain components attributable to the second load. Moreover, as mentioned earlier, this second load may fluctuate depending on temperature. Therefore, it is not easy to accurately detect air entrapment over a wide temperature range based solely on the actual rotational speed itself or the motor current value itself. For example, as illustrated in FIG. 10, even in the normal state, when the temperature is high, the fluctuation in the actual rotational speed and the motor current value are small. On the other hand, as illustrated in FIG. 11, even in the air entrapped state, when the temperature is low, the fluctuation in the actual rotational speed and the motor current value are large. Consequently, a difference between a magnitude of the fluctuation in the normal state and a high temperature environment (see FIG. 10) and a magnitude of the fluctuation in the air entrapped state and a low temperature environment (see FIG. 11) is small. This means that in the normal state and a high temperature environment, there is a possibility that the air entrapped state may be mistakenly detected even when there is no air entrapment. In the air entrapped state and a low temperature environment, there is a possibility of being mistakenly determined as normal state despite not being in the normal state.

Therefore, in the first embodiment, the control circuit 80 (air entrapment detector 90) detects air entrapment based on an actual operating amount (or an actual operating quantity) of the electric-powered lubricant dispenser 1. The actual operating amount has a magnitude corresponding to the magnitude of the specific load. As described above, the specific load includes the first load but does not include at least part of the second load. That is, in the specific load, the component of the second load is reduced or removed. Therefore, based on the actual operating amount, air entrapment detection with high accuracy, in which the influence of the second load is reduced or removed, can be performed. Thus, the air entrapment detector 90 determines that air entrapment has occurred based on the actual operating amount satisfying the specified requirement during driving of the motor 20.

The actual operating amount is specifically an amplitude of a filtered physical quantity. The filtered physical quantity is obtained by reducing or removing a component attributable to the second load from a load physical quantity. The load physical quantity is a physical quantity that varies depending on a magnitude of the motor load. The amplitude of the filtered physical quantity has a magnitude corresponding to the magnitude of the specific load. Therefore, air entrapment can be detected based on the amplitude of the filtered physical quantity. Since the third load is constant or nearly constant, the amplitude of the filtered physical quantity is obtained by further significantly reducing or removing a component attributable to the third load from the load physical quantity. Consequently, the amplitude of the filtered physical quantity is equal to or nearly equal to an amplitude of the first load.

The filtered physical quantity can be calculated using various methods that can reduce or remove the component attributable to the second load from the load physical quantity. In the first embodiment, a moving average (specifically, a value of the moving average) of the load physical quantity is calculated as the filtered physical quantity. The load physical quantity itself contains the component attributable to the second load. As described above, the second load periodically fluctuates with each one-way movement of the slider 48. Therefore, calculating the moving average of the load physical quantity can significantly reduce or remove the component attributable to the second load in the load physical quantity.

Calculation target time for the moving average is half the required reciprocating time. The required reciprocating time is time required for the plunger 50 to complete one reciprocation. By calculating the average of multiple load physical quantities acquired during the calculation target time as such, the filtered physical quantity is obtained.

The air entrapment detector 90 acquires and stores the load physical quantity at each calculation timing. In the first embodiment, the calculation timing occurs repeatedly at a control cycle.

The air entrapment detector 90 further calculates the moving average of the load physical quantity at each calculation timing. Specifically, the air entrapment detector 90 calculates calculation target time from the desired rotational speed set at that calculation timing at each calculation timing. More specifically, the air entrapment detector 90 assumes that the plunger 50 was rotating at a constant speed at the current desired rotational speed. The reduction ratio from the motor 20 to the slider 48 is known. Therefore, an amount of travel of the plunger 50 per rotation of the motor 20 is known, and consequently, an amount of rotation of the motor 20 required for the plunger 50 to travel half the reciprocating distance is also known. Thus, the air entrapment detector 90 can calculate the calculation target time from the desired rotational speed.

The air entrapment detector 90 calculates an average of the multiple load physical quantities stored during a calculation target period as the moving average at each calculation timing. The calculation target period is a period from a calculation timing before the current calculation timing to the current calculation timing.

The air entrapment detector 90 may calculate the moving average of any load physical quantity. Examples of the load physical quantities include the motor current value, the actual rotational speed, and a load torque. The load physical quantity in the first embodiment is, for example, the motor current value. In other words, the air entrapment detector 90 in the first embodiment calculates the moving average of the motor current value based on the current detection signal.

The air entrapment detector 90 determines that air entrapment has occurred when the moving average of the motor current value (i.e., the filtered physical quantity) satisfies the specified requirement. In the first embodiment, the specified requirement includes the maximum amplitude of the moving average, repeatedly calculated within a specified drive period, being less than or equal to a first current threshold. The amplitude of the moving average may be understood as a difference between the moving averages calculated at each of two consecutive calculation timings.

The specified drive period may be any period during driving of the motor 20. In the first embodiment, the specified drive period is one reciprocating period of the plunger 50. Multiple calculation timings occur during one reciprocating period. Therefore, multiple moving averages are calculated during one reciprocating period. The difference between the maximum value and the minimum value among these multiple moving averages is the maximum amplitude of the moving average. The air entrapment detector 90 determines whether air entrapment has occurred based on the maximum amplitude of the moving average calculated during the one reciprocating period and the first current threshold, each time the specified drive period elapses (i.e., each time the plunger 50 completes one reciprocation).

As illustrated in FIG. 13, in the air entrapped state and a low-temperature environment, the fluctuation in the motor current value becomes large despite occurrence of air entrapment, and the difference between that fluctuation and the fluctuation in the normal state is small. However, the moving average of the motor current value shows a significant reduction in the influence of the second load, resulting in very small fluctuation. The same applies to the actual rotational speed. That is, in a low-temperature environment, even when air entrapment occurs, the fluctuation in the actual rotational speed becomes large, and the difference between that fluctuation and the fluctuation in the normal state is small. However, the moving average of the actual rotational speed shows a significant reduction in the influence of the second load, resulting in very small fluctuation.

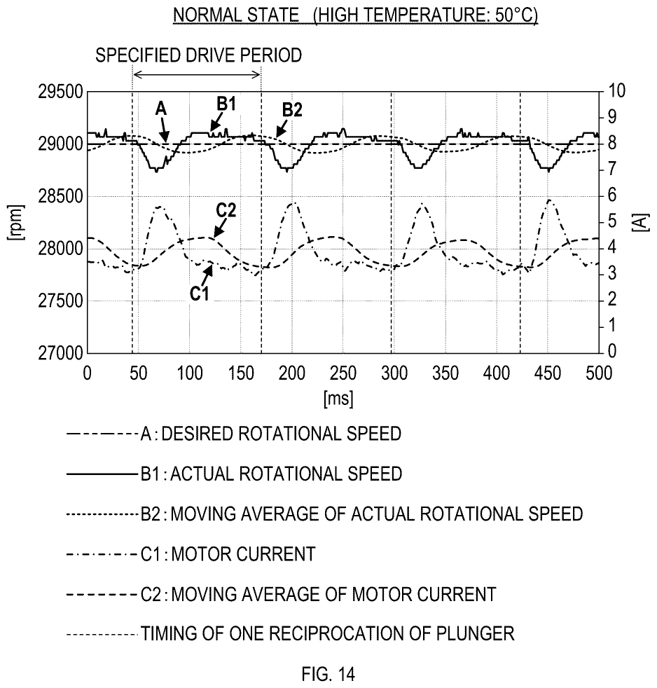

On the other hand, in the normal state and a high-temperature environment, as illustrated in FIG. 14, both the moving average of the motor current value and the moving average of the actual rotational speed exhibit fluctuations of a certain magnitude corresponding to the pressure from the grease. These fluctuations are significantly larger than those in the air entrapped state and a low-temperature environment, as is evident when compared to FIG. 13.

Although not shown, the load torque applied to the motor 20 also includes a component attributable to the second load. However, a moving average of the load torque shows significant reduction in the influence of the second load. Consequently, similar to the fluctuation in the motor current value, the fluctuation in the moving average of the load torque in the normal state is sufficiently larger than the fluctuation in the moving average of the load torque in the air entrapped state.

Therefore, based on the moving average of the motor current value, air entrapment can be detected accurately over a wide temperature range. By using the moving average of the actual rotational speed and the moving average of the load torque, air entrapment can also be detected accurately, similar to when using the moving average of the motor current value. The second embodiment described later illustrates air entrapment detection based on the moving average of the actual rotational speed, and the third embodiment described later illustrates air entrapment detection based on the moving average of the load torque.

The first current threshold may be set to a value smaller than a first expected range and larger than a second expected range. The first expected range is a range of the moving average of the motor current value expected in the normal state. The second expected range is a range of the moving average of the motor current value expected in the air entrapped state. The first current threshold may be less than a minimum value of the first expected range and larger than a maximum value of the second expected range. The first current threshold may be determined in any manner.

The first current threshold may be a fixed value or may be variably set in accordance with the operating state of the electric-powered lubricant dispenser 1. In the first embodiment, the first current threshold is variably set depending on the operating state.

In the first embodiment, the operating state includes the desired rotational speed. That is, the air entrapment detector 90 sets the first current threshold based on the current desired rotational speed notified from the speed setter 86.

When the desired rotational speed changes, the moving average of the motor current value also changes accordingly. The moving average of the motor current value tends to increase as the desired rotational speed becomes higher. Furthermore, the lower the desired rotational speed is, the more the fluctuation in the actual rotational speed is reduced by the speed feedback control, thereby also reducing the fluctuation in the motor current value. However, in a high-speed range, inertial force of the pump 60 becomes large. Therefore, in the high-speed range, the fluctuation in the motor current value conversely becomes smaller as the actual rotational speed increases.

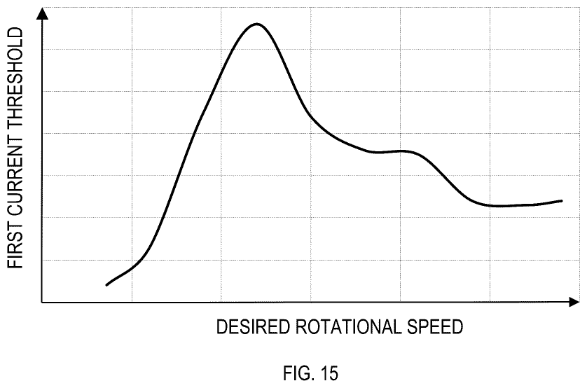

Therefore, the first current threshold may be set such that, for example, (i) in a low-speed to medium-speed range, the first current threshold increases as the desired rotational speed increases, and (ii) in the high-speed range, the first current threshold decreases as the desired rotational speed increases. More specifically, the first current threshold may be set in accordance with the desired rotational speed, as illustrated in FIG. 15.

The operating state may include the actual rotational speed. In other words, the first current threshold may be set in accordance with the actual rotational speed. In that case as well, the first current threshold may be set in the same manner as setting the first current threshold in accordance with the desired rotational speed. For example, a horizontal axis in FIG. 15 may be interpreted as the actual rotational speed.

The operating state may also include the aforementioned duty ratio. In other words, the first current threshold may be set in accordance with the duty ratio. The first current threshold may vary in accordance with the duty ratio. For example, the first current threshold may increase as the duty ratio increases. In that case as well, the first current threshold may be set in the same manner as setting the first current threshold in accordance with the desired rotational speed. For example, the horizontal axis in FIG. 15 may be interpreted as the duty ratio.

Furthermore, the operating state may include a device temperature. In other words, the first current threshold may be set in accordance with the device temperature. The device temperature is the temperature of the electric-powered lubricant dispenser 1. Specifically, the device temperature may be the temperature of the grease, or a temperature indirectly indicating the temperature of the grease.

Viscosity of the grease changes with its temperature. For example, as the temperature of the grease increases, the viscosity of the grease decreases. When the viscosity of the grease decreases, the first load (and consequently, the motor load) decreases, thereby reducing the amplitude of the moving average of the motor current value. Therefore, the first current threshold may be set to decrease as the temperature of the grease increases. The air entrapment detector 90 may set the first current threshold in accordance with the temperature detected by the temperature sensor 100.

The time counter 88 measures an air entrapment duration when air entrapment occurs. The air entrapment duration is time during which air entrapment continues. Specifically, the time counter 88 begins measuring the air entrapment duration when the air entrapment detection state changes from “Not Detected” to “Detected”. Specifically, the time counter 88 accumulates (cumulatively adds) a count value incrementally at each calculation timing. When the air entrapment duration reaches a specified time (i.e., when the count value reaches a specified value), the time counter 88 notifies the operation controller 91 that air entrapment has been continuing for the specified time. Specifically, the time counter 88 sets an air entrapment continuation state to “Detected”.

The reciprocating count calculator 79 calculates the actual reciprocating count of the plunger 50 when the operation mode is set to the automatic dispensing mode. The reciprocating count calculator 79 may also calculate the reciprocating count when the operation mode is set to the continuous dispensing mode. The actual reciprocating count is the actual number of reciprocations of the plunger 50. In other words, the actual reciprocating count is the number of times the dispensing operation was actually performed.

The reciprocating count calculator 79 accumulates (i.e., cumulatively adds) the actual reciprocating count each time a reciprocation determination signal is received from the plunger-related detector 89 (i.e., each time the plunger 50 completes one reciprocation). Specifically, each time the reciprocating count calculator 79 receives a reciprocation determination signal, the actual reciprocating count is updated, adding “1” to the current value.

However, the reciprocating count calculator 79 does not update the actual reciprocating count while air entrapment is detected by the air entrapment detector 90 (i.e., while the air entrapment detection state is set to “Detected”). In other words, the reciprocating count calculator 79 temporarily stops accumulation of the actual reciprocating count. After temporarily stopping the accumulation of the actual reciprocating count, the reciprocating count calculator 79 resumes the accumulation from the value at the time of temporary stop once the air entrapment is resolved and the air entrapment detection state is set to “Not Detected”.

The reciprocating count calculator 79 notifies the display controller 85 of the current actual reciprocating count. Furthermore, the reciprocating count calculator 79 outputs a remaining reciprocating count to the operation controller 91. The remaining reciprocating count is the difference between the desired reciprocating count and the current actual reciprocating count.

In the continuous dispensing mode, the operation controller 91 instructs the motor drive controller 92 to drive the motor 20 while the trigger switch 8 is on. Specifically, the operation controller 91 outputs a drive command to the motor drive controller 92 and notifies the motor drive controller 92 of the current desired rotational speed. The drive command requests the motor drive controller 92 to drive the motor 20.

In the automatic dispensing mode, the operation controller 91 instructs the motor drive controller 92 to drive the motor 20 while the trigger switch 8 is on. Specifically, the operation controller 91 outputs a drive command to the motor drive controller 92 and notifies the motor drive controller 92 of the current desired rotational speed. When the remaining reciprocating count notified by the reciprocating count calculator 79 reaches zero, output of the drive command is stopped to stop the motor 20.

During operation in the automatic dispensing mode, if the time counter 88 sets the air entrapment continuation state to “Detected” (meaning that air entrapment has continued for a specified time), the operation controller 91 stops outputting the drive command and stops the motor 20, even if the trigger switch 8 is on and the remaining reciprocating count has not yet reached zero.

The motor drive controller 92 calculates the rotational position (specifically, the electrical angle) and the actual rotational speed of the motor 20 based on the first through third rotation signals from the first through third rotational position sensors 28A through 28C.

When the drive command and the desired rotational speed are received from the operation controller 91, the motor drive controller 92 performs speed feedback control. Specifically, the motor drive controller 92 calculates a speed deviation. The speed deviation is a difference between the desired rotational speed and the actual rotational speed. The motor drive controller 92 then calculates the duty ratio required to remove the speed deviation (i.e., to make the actual rotational speed consistent to the desired rotational speed). The motor drive controller 92 then outputs a drive control signal to each of the two on-target switches to turn on the corresponding target switch. The two on-target switches are two switches selected from the first through sixth switches Q1 through Q6 based on the rotational position. At least one of the drive control signals to the two on-target switches is a pulse width modulation signal having the calculated duty ratio. Therefore, the higher the duty ratio, the greater the electric power supplied to the motor 20.

The display controller 85 displays the rotational speed range input from the operation mode setter 87 on the first display screen 74. The display controller 85 displays the actual reciprocating count input from the reciprocating count calculator 79 on the set count display screen 75. The display controller 85 executes a notification process when occurrence of air entrapment is notified. The notification process notifies the user that air entrapment has occurred. The notification process may be performed in any manner. The notification process may be performed to enable visual and/or auditory recognition that air entrapment has occurred. In the first embodiment, the display controller 85 notifies the user of air entrapment by flashing the second display screen 75A and the third display screen 75B. Alternatively, the display controller 85 may notify the user of air entrapment by displaying a preset numerical value, symbol, character, etc., on the second display screen 75A and the third display screen 75B. The display controller 85 is one example of the notifier in Overview of Embodiments.

### 2-1-6. Main Process

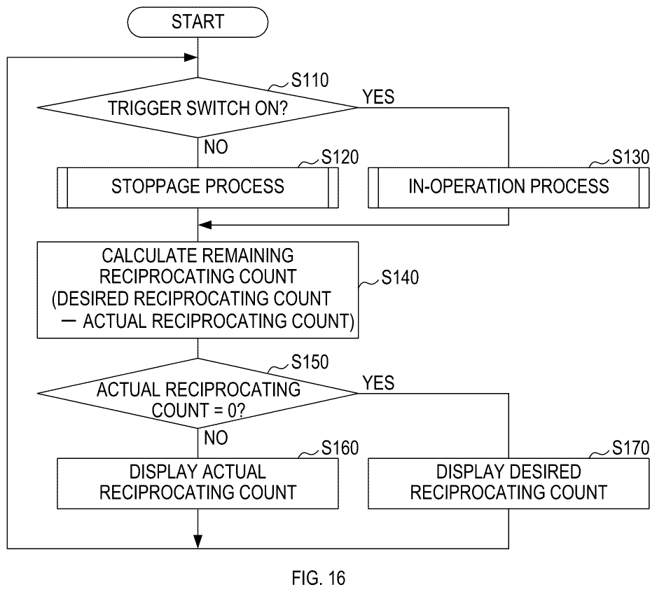

Referring to FIG. 16, the main process for achieving various functions in the automatic dispensing mode is described. When the operation mode is set to the automatic dispensing mode, the control circuit 80 (more specifically, the CPU 80A) executes the main process shown in FIG. 16.

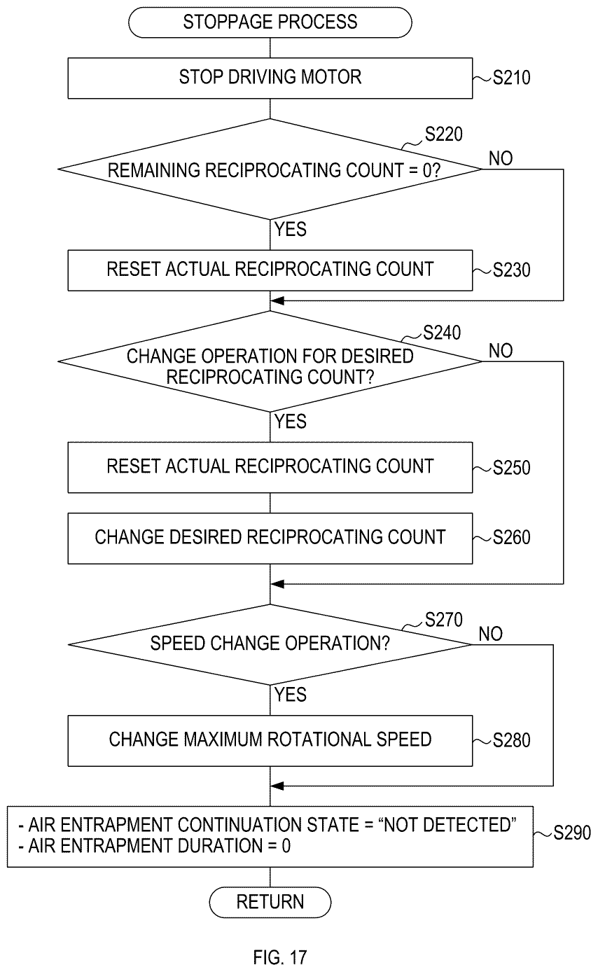

The control circuit 80, when starting the main process, determines in S110 whether the trigger switch 8 is on. If the trigger switch 8 is off, the process proceeds to S120. In S120, the control circuit 80 executes a stoppage process. Details of the stoppage process are shown in FIG. 17.

The control circuit 80, when proceeding to the stoppage process, stops driving the motor 20 in S210. Specifically, the operation controller 91 stops outputting the drive command. In S220, the control circuit 80 determines whether the current remaining reciprocating count is zero. If the remaining reciprocating count is not zero, the process proceeds to S240. In this case, the current remaining reciprocating count is maintained. If the remaining reciprocating count is zero, the process proceeds to S230. For example, when the plunger 50 has completed the desired number of reciprocations, causing the motor 20 to automatically stop, and the trigger 9 is turned off by the user based on the automatic stopping of the motor 20, the remaining reciprocating count may be determined as zero in S220. In S230, the control circuit 80 resets the actual reciprocating count to an initial value (e.g., zero).

In S240, the control circuit 80 determines whether a change operation for the desired reciprocating count has been performed. The change operation includes the second switch 72 or the third switch 73 being turned on. If no change operation has been performed, the process proceeds to S270. If a change operation has been performed, the process proceeds to S250.

In S250, the control circuit 80 resets the actual reciprocating count to its initial value. In S260, the control circuit 80 changes the desired reciprocating count in accordance with the change operation.

In S270, the control circuit 80 determines whether a speed change operation has been performed. The speed change operation includes the first switch 71 being turned on. If no speed change operation has been performed, the process proceeds to S290. If the speed change operation has been performed, the process proceeds to S280. In S280, the control circuit 80 changes the rotational speed range (i.e., changes the maximum rotational speed) in response to the speed change operation.

In S290, the control circuit 80 sets the air entrapment continuation state to “Not Detected”. The control circuit 80 further sets the air entrapment duration to zero (that is, resets the air entrapment duration). After S290, the process proceeds to S140 (FIG. 16).

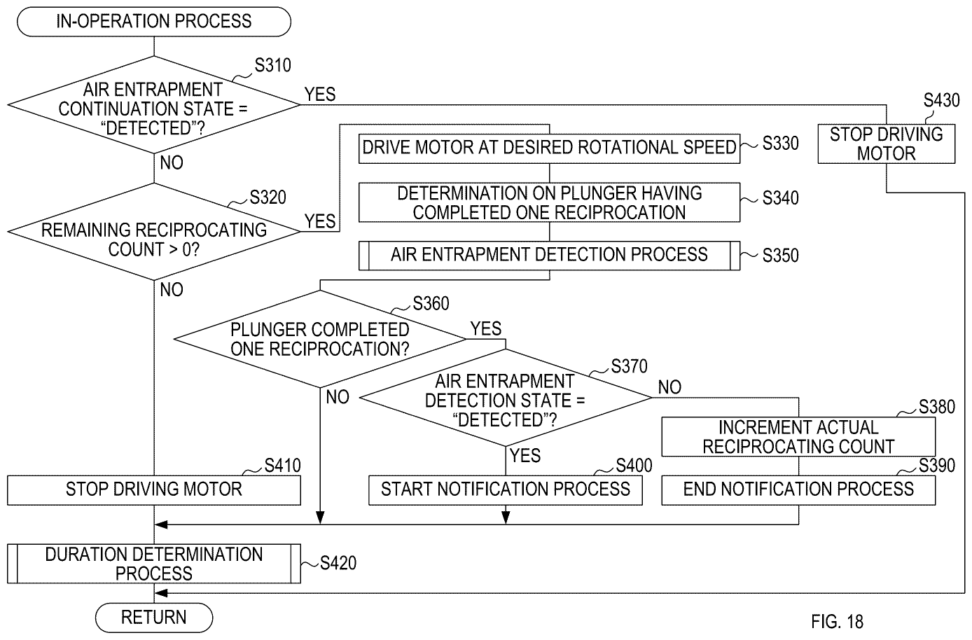

If the trigger switch 8 is on in S110, the process proceeds to S130. In S130, the control circuit 80 executes an in-operation process. Details of the in-operation process are shown in FIG. 18.

The control circuit 80, when proceeding to the in-operation process, determines in S310 whether the air entrapment continuation state is set to “Detected”. If the air entrapment continuation state is not set to “Detected”, the process proceeds to S320. In S320, the control circuit 80 determines whether the current remaining reciprocating count is greater than zero. If the remaining reciprocating count is zero, the control circuit 80 stops driving the motor 20 in S410, as in S210. The remaining reciprocating count being zero corresponds to the dispensing operation having been executed the desired number of reciprocations. After S410, the process proceeds to S420.

In S320, if the remaining reciprocating count is greater than zero, the process proceeds to S330. The remaining reciprocating count being greater than zero corresponds to the actual reciprocating count not yet reaching the desired reciprocating count. In S330, the control circuit 80 drives the motor 20 at the desired rotational speed corresponding to the current rotational speed range. That is, the control circuit 80 executes the aforementioned speed feedback control.

In S340, the control circuit 80 determines whether the plunger 50 has completed one reciprocation.

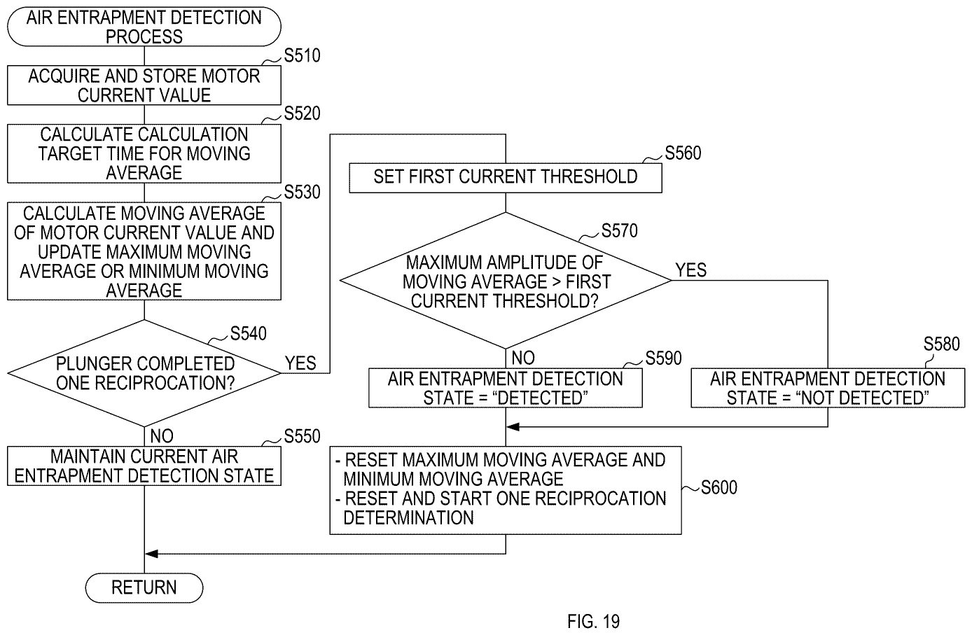

In S350, the control circuit 80 executes an air entrapment detection process. The air entrapment detection process is a process to detect whether air entrapment has occurred. Details of the air entrapment detection process are shown in FIG. 19. The control circuit 80, when proceeding to the air entrapment detection process, acquires the motor current value in S510 and stores the motor current value in the semiconductor memory 80B.

In S520, the control circuit 80 calculates the calculation target time for the moving average (i.e., half the required reciprocating time) based on the current desired rotational speed, for example, using the aforementioned method.

In S530, the control circuit 80 calculates the moving average of the motor current value based on the calculation target time calculated in S520. Specifically, the control circuit 80 calculates the moving average as the average of the multiple motor current values acquired and stored during the calculation target period. The calculation target period spans from the current calculation timing back to the calculation target time. The control circuit 80 further updates the maximum moving average or minimum moving average based on the calculated moving average. The maximum moving average and minimum moving average (i) are reset each time the plunger 50 completes one reciprocation, and (ii) may be updated each time S530 is executed after reset. Specifically, if the latest moving average calculated in the current S530 is greater than the currently held maximum moving average, the maximum moving average is updated to the latest moving average. If the latest moving average calculated in the current S530 is less than the currently held minimum moving average, the minimum moving average is updated to the latest moving average.

In S540, the control circuit 80 determines whether the plunger 50 has completed one reciprocation based on the result of determination in S340. If the plunger 50 has not yet completed one reciprocation, the process proceeds to S550. In S550, the control circuit 80 maintains the current air entrapment detection state (“Detected” or “Not Detected”). After S550, the process proceeds to S360 (FIG. 18).

In S540, when the plunger 50 completes one reciprocation, the process proceeds to S560. In S560, the control circuit 80 sets the first current threshold. Specifically, as described above, the control circuit 80 sets the first current threshold based on the desired rotational speed, the duty ratio, the actual rotational speed, or the device temperature.

In S570, the control circuit 80 determines whether the maximum amplitude of the moving average of the motor current value (i.e., the maximum value of the amplitude of the moving average in the previous reciprocating period) is greater than the first current threshold. The maximum amplitude is a difference between the maximum moving average and the minimum moving average currently held. For each reciprocation of the plunger 50, the maximum moving average and minimum moving average during that reciprocation are obtained in S530. The difference between these two averages is the maximum amplitude.

If the maximum amplitude is greater than the first current threshold, the process proceeds to S580. In this case, the control circuit 80 determines that no air entrapment has occurred. Therefore, in S580, the control circuit 80 sets the air entrapment detection state to “Not Detected”. After S580, the process proceeds to S600.

If the maximum amplitude is less than or equal to the first current threshold, the process proceeds to S590. In this case, the control circuit 80 determines that air entrapment has occurred. Therefore, in S590, the control circuit 80 sets the air entrapment detection state to “Detected”. After S590, the process proceeds to S600.

In S600, the control circuit 80 resets the currently held maximum moving average and minimum moving average. The control circuit 80 further resets the result of determination in S340 that the plunger 50 has completed one reciprocation, thereby restarting the determination of whether the plunger 50 has completed one reciprocation. Therefore, when the plunger 50 completes another reciprocation starting from this restart timing, it is determined again in S340 that the plunger 50 has completed one reciprocation. After S600, the process proceeds to S360 (FIG. 18).

In S360, the control circuit 80 determines whether the plunger 50 has completed one reciprocation based on the result of determination in S340. If the plunger 50 has not completed one reciprocation, the process proceeds to S420. If the plunger 50 has completed one reciprocation, the process proceeds to S370.

In S370, the control circuit 80 determines whether the air entrapment detection state is set to “Detected”. If the air entrapment detection state is set to “Detected”, meaning that air entrapment has occurred, the process proceeds to S400. In S400, the control circuit 80 initiates the aforementioned notification process. That is, the control circuit 80 notifies the user that air entrapment has occurred. After S400, the process proceeds to S420.

In S370, if the air entrapment detection state is not set to “Detected,” meaning that no air entrapment has occurred, the process proceeds to S380. In S380, the control circuit 80 increments the actual reciprocating count. That is, the control circuit 80 updates the actual reciprocating count with the current count plus “1”. In S390, if the notification process is being executed, the control circuit 80 terminates the notification process. After S390, the process proceeds to S420.

If the air entrapment detection state is set to “Detected” in S370, the actual reciprocating count is not incremented, and the current actual reciprocating count is maintained. That is, while air entrapment is detected, even if the plunger 50 completes one reciprocation, the actual reciprocating count is not changed.

If the air entrapment continuation state is set to “Detected” in S310, the process proceeds to S430. In S430, the control circuit 80 stops driving the motor 20, as in S210. After S430, the process proceeds to S140 (FIG. 16).

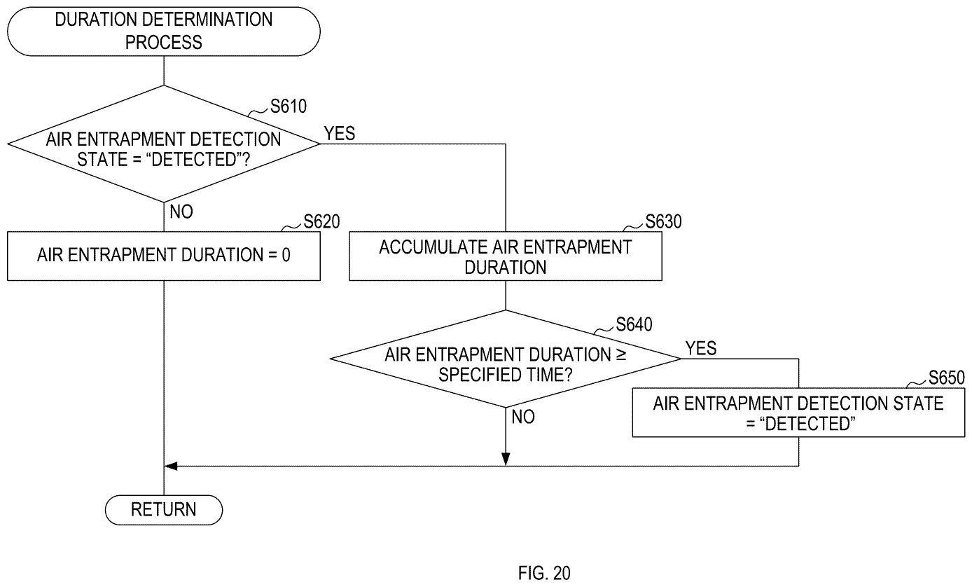

In S420, the control circuit 80 executes a duration determination process. Details of the duration determination process are shown in FIG. 20. Upon proceeding to the duration determination process, the control circuit 80 determines in S610 whether the air entrapment detection state is set to “Detected”. If the air entrapment detection state is not set to “Detected”, meaning no air entrapment has occurred, the process proceeds to S620.

In S620, the control circuit 80 resets the air entrapment duration to zero. After S620, the process proceeds to S140 (FIG. 16).

If the air entrapment detection state is set to “Detected” in S610, meaning that air entrapment has occurred, the process proceeds to S630. In S630, the control circuit 80 accumulates the air entrapment duration. That is, the control circuit 80 increments (accumulates) the aforementioned count value used for measurement by one.

In S640, the control circuit 80 determines whether the air entrapment duration is longer than or equal to a specified time (i.e., whether the count value is greater than or equal to a specified value). If the air entrapment duration is less than the specified time, the process proceeds to S140 (FIG. 16). If the air entrapment duration is equal to or longer than the specified time, the process proceeds to S650.

In S650, the control circuit 80 sets the air entrapment continuation state to “Detected”. That is, it is determined that air entrapment has been continuing for a specified time or longer. After S650, the process proceeds to S140 (FIG. 16).

In S140, the control circuit 80 calculates (i.e., updates) the remaining reciprocating count. Specifically, the control circuit 80 subtracts the current actual reciprocating count from the current desired reciprocating count and updates the remaining reciprocating count with the resulting difference.

In S150, the control circuit 80 determines whether the current actual reciprocating count is zero. If the actual reciprocating count is not zero, the process proceeds to S160. In this case, the plunger 50 has already moved at least one reciprocating distance in the automatic dispensing mode. Therefore, in S160, the control circuit 80 displays the current actual reciprocating count on the set count display screen 75. This allows the user to confirm how far the dispensing of grease has progressed. After S160, the process proceeds to S110.

If the actual reciprocating count is zero in S150, the process proceeds to S170. In this case, it is possible that, for example, the trigger 9 has not yet been manually operated, or that the trigger 9 was manually operated but the actual reciprocating count has not yet reached one reciprocation. Therefore, in S170, the control circuit 80 displays the desired reciprocating count on the set count display screen 75. This allows the user to confirm the desired reciprocating count. After S170, the process proceeds to S110.

Here, correspondence between the processes in FIGS. 16 through 20 and FIG. 6 is briefly explained. S110, S310, and S320 correspond to processing by the operation controller 91. S210, S330, S410, and S430 correspond to processing by the operation controller 91 and the motor drive controller 92. S140, S220, S230, S250, and S380 correspond to processing by the reciprocating count calculator 79. S240 and S260 correspond to processing by the reciprocating count setter 83. S270 and S280 correspond to processing by the operation mode setter 87. S290 and S420 correspond to processing by the time counter 88. S340 and S360 correspond to processing by the plunger-related detector 89. S350 corresponds to processing by the air entrapment detector 90. S370 corresponds to processing by the reciprocating count calculator 79 and the display controller 85. S150 through S170, S390, and S400 correspond to processing by the display controller 85.

### 2-2. Second Embodiment

Another example of the air entrapment detection process is described as the second embodiment. The electric-powered lubricant dispenser of the second embodiment is configured essentially the same as the electric-powered lubricant dispenser 1 of the first embodiment, except for the air entrapment detection process. That is, the electric-powered lubricant dispenser of the second embodiment also executes the process shown in FIGS. 16 through 18 and FIG. 20. Hereinafter, the configuration differing from that of the first embodiment is described.

The second embodiment differs from the first embodiment in the load physical quantity used to calculate the moving average. In the first embodiment, the load physical quantity was the motor current value. In contrast, the load physical quantity in the second embodiment is the actual rotational speed of the motor 20. The actual rotational speed may fluctuate periodically during operation of the pump 60. That is, the amplitude of the actual rotational speed is generated during operation of the pump 60. The amplitude of the actual rotational speed in the normal state differs from the amplitude in the air entrapped state. Furthermore, the amplitude of the actual rotational speed includes a component attributable to the second load.

Therefore, in the second embodiment, the air entrapment detector 90 calculates the moving average of the actual rotational speed. A period over which the moving average is calculated is the same as in the first embodiment. The air entrapment detector 90 then determines that air entrapment has occurred when the moving average satisfies a specified requirement. In the second embodiment, the specified requirement includes the maximum amplitude of the moving average, repeatedly calculated over a specified drive period, being less than or equal to the first speed threshold. The specified drive period is, as in the first embodiment, one reciprocating period of the plunger 50.

The first speed threshold may be set to a value smaller than a third expected range and larger than a fourth expected range. The third expected range is a range of the moving average of the actual rotational speed expected in the normal state. The fourth expected range is a range of the moving average of the actual rotational speed expected in the air entrapped state. The first speed threshold may be less than a minimum value of the third expected range and larger than a maximum value of the fourth expected range.

The first speed threshold may be a fixed value. In the second embodiment, the first speed threshold is variably set in accordance with the operating state of the electric-powered lubricant dispenser 1, similar to the first current threshold in the first embodiment.

Specifically, the first speed threshold may be set in accordance with the desired rotational speed. More specifically, the first speed threshold may be set in the same manner as the first current threshold. For example, a vertical axis in FIG. 15 may be interpreted as the first speed threshold. Furthermore, for example, the first speed threshold may be set in accordance with various operating states in the same manner as the first current threshold.

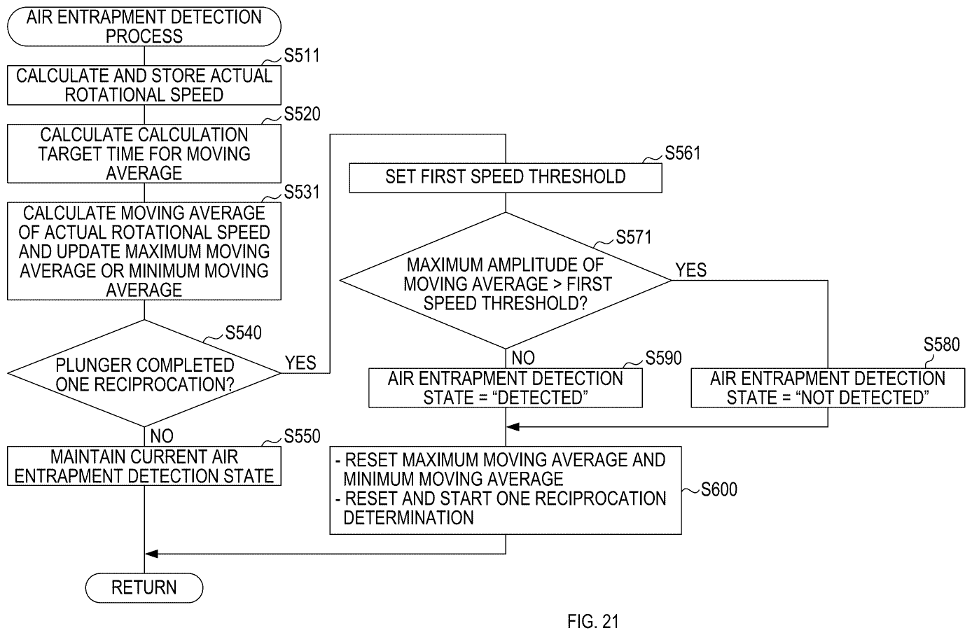

To achieve such air entrapment detection, in the second embodiment, in S350 in FIG. 18, the air entrapment detection process shown in FIG. 21 is executed instead of the air entrapment detection process shown in FIG. 19.

The air entrapment detection process in FIG. 21 differs from the air entrapment detection process in FIG. 19 in that (i) S511 is executed instead of S510, (ii) S531 is executed instead of S530, (iii) S561 is executed instead of S560, and (iv) S571 is executed instead of S570. Steps identical to those in the air entrapment detection process of FIG. 19 are labeled with the same reference numerals as in FIG. 19, and detailed descriptions thereof are omitted.

In S511, the control circuit 80 calculates the current actual rotational speed and stores that actual rotational speed in the semiconductor memory 80B.

In S531, the control circuit 80 calculates the moving average of the actual rotational speed based on the calculation target time calculated in S520. Specifically, the control circuit 80 calculates the average of the multiple actual rotational speeds calculated and stored during the calculation target period as the moving average. The control circuit 80 further updates the maximum moving average or minimum moving average, as in the first embodiment.

In S561, the control circuit 80 sets the first speed threshold. Specifically, the control circuit 80 sets the first speed threshold based on the desired rotational speed, the duty ratio, the actual rotational speed, or the device temperature, as described above.

In S571, the control circuit 80 determines whether the maximum amplitude of the moving average of the actual rotational speed is greater than the first speed threshold. If the maximum amplitude is greater than the first speed threshold, the process proceeds to S580. In this case, the control circuit 80 determines that air entrapment has not occurred and sets the air entrapment detection state to “Not Detected”. If the maximum amplitude is less than or equal to the first speed threshold, the process proceeds to S590. In this case, the control circuit 80 determines that air entrapment has occurred and sets the air entrapment detection state to “Detected”.

### 2-3. Third Embodiment

The third embodiment describes yet another example of the air entrapment detection process. The electric-powered lubricant dispenser of this third embodiment is configured essentially the same as the electric-powered lubricant dispenser 1 of the first embodiment, except for the air entrapment detection process. That is, the electric-powered lubricant dispenser of the third embodiment also executes the processes shown in FIGS. 16 through 18 and FIG. 20. The configuration differing from that of the first embodiment is described below.

The difference between the third embodiment and the first embodiment lies in the load physical quantity used for calculating the moving average. Specifically, the load physical quantity in the third embodiment is the load torque of the motor 20. The load torque is a torque applied to the motor 20 from outside the motor.

The load torque may fluctuate periodically during operation of the pump 60. That is, an amplitude of the load torque is generated during operation of the pump 60. The amplitude of the load torque in the normal state differs from the amplitude of the load torque in the air entrapped state. Furthermore, the amplitude of the load torque includes a component attributable to the second load.

The load torque may be acquired by any method. The air entrapment detector 90 of the third embodiment calculates (i.e., estimates) the load torque based on the aforementioned formula (1). The air entrapment detector 90 can acquire the motor current value based on the current detection signal and calculate the motor acceleration from the actual rotational speed. Furthermore, the motor torque coefficient and the moment of inertia can be identified theoretically or experimentally and are therefore known. Consequently, the load torque can be calculated from formula (1).

The air entrapment detector 90 calculates the load torque and calculates the moving average of the load torque. The air entrapment detector 90 determines that air entrapment has occurred when the moving average of the load torque satisfies a specified requirement. In the third embodiment, the specified requirement includes the maximum amplitude of the moving average, repeatedly calculated over a specified drive period, being less than or equal to a first torque threshold. The specified drive period may be any period during operation of the motor 20. In the third embodiment, the specified drive period is, as in the first embodiment, one reciprocating period of the plunger 50.

The first torque threshold may be set to a value smaller than a fifth expected range and larger than a sixth expected range. The fifth expected range is a range of the moving average of the load torque expected in the normal state. The sixth expected range is a range of the moving average of the load torque expected in the air entrapped state. The first torque threshold may be less than a minimum value of the fifth expected range and larger than a maximum value of the sixth expected range.

The first torque threshold may be a fixed value. In the third embodiment, the first torque threshold is variably set in accordance with the operating state of the electric-powered lubricant dispenser 1, similar to the first current threshold in the first embodiment.

Specifically, the first torque threshold may be set in accordance with the desired rotational speed. More specifically, the first torque threshold may be set in the same manner as the first current threshold. For example, the vertical axis in FIG. 15 may be interpreted as the first torque threshold. Furthermore, for example, the first torque threshold may be set in accordance with various operating states in the same manner as the first current threshold.

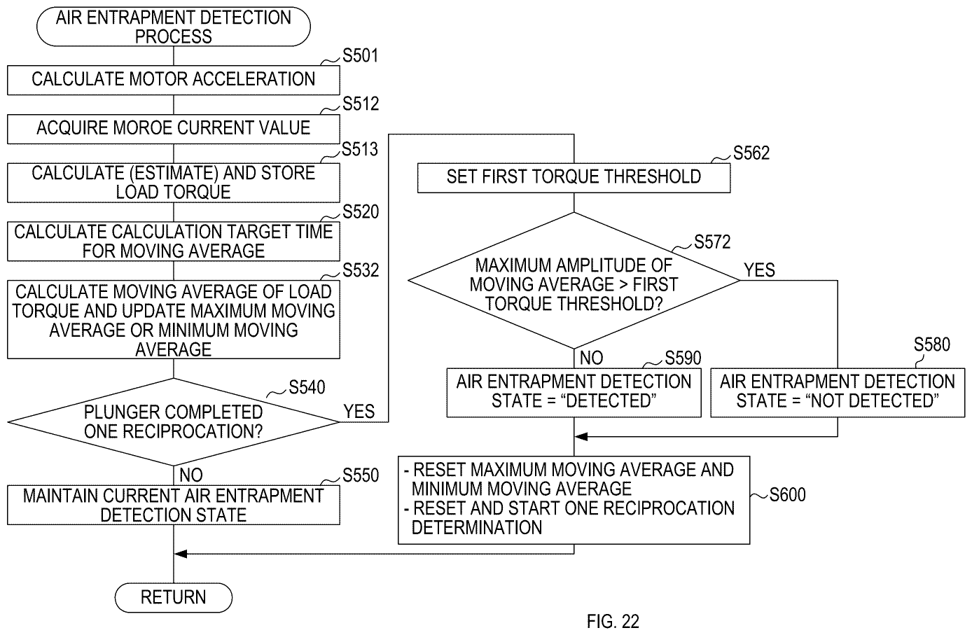

To achieve such air entrapment detection, in the third embodiment, in S350 in FIG. 18, the air entrapment detection process shown in FIG. 22 is executed instead of the air entrapment detection process in FIG. 19.

The air entrapment detection process in FIG. 22 differs from that in FIG. 19 in that (i) S512 and S513 are executed instead of S510, (ii) S501 is executed before S512, (iii) S532 is executed instead of S530, (iv) S562 is executed instead of S560, and (v) S572 is executed instead of S570. Steps identical to those in the air entrapment detection process of FIG. 19 are labeled with the same reference numerals as in FIG. 19, and detailed descriptions thereof are omitted.

In S501, the control circuit 80 calculates the current actual rotational speed and calculates the motor acceleration based on that actual rotational speed.

In S512, the control circuit 80 acquires the motor current value based on the current detection signal.

In S513, the control circuit 80 calculates the load torque based on the formula (1) using the motor acceleration and the motor current value obtained in S501 and S512. The control circuit 80 further stores the calculated load torque in the semiconductor memory 80B.

In S532, the control circuit 80 calculates the moving average of the load torque based on the calculation target time calculated in S520. Specifically, the control circuit 80 calculates the average of the multiple load torques calculated and stored during the calculation target period as the moving average. The control circuit 80 further updates the maximum moving average or the minimum moving average, as in the first embodiment.

In S562, the control circuit 80 sets the first torque threshold. Specifically, as described above, the control circuit 80 sets the first torque threshold based on the desired rotational speed, the duty ratio, the actual rotational speed, or the device temperature.

In S572, the control circuit 80 determines whether the maximum amplitude of the moving average of the load torque is greater than the first torque threshold. If the maximum amplitude is greater than the first torque threshold, the process proceeds to S580. In this case, the control circuit 80 determines that no air entrapment has occurred and sets the air entrapment detection state to “Not Detected”. If the maximum amplitude is less than or equal to the first torque threshold, the process proceeds to S590. In this case, the control circuit 80 determines that air entrapment has occurred and sets the air entrapment detection state to “Detected”.

### 2-4. Fourth Embodiment

In the fourth embodiment, yet another example of the air entrapment detection process is described. The electric-powered lubricant dispenser of the fourth embodiment is configured essentially the same as the electric-powered lubricant dispenser 1 of the first embodiment, except for the air entrapment detection process. That is, the electric-powered lubricant dispenser of the fourth embodiment also executes the processes shown in FIGS. 16 through 18 and FIG. 20. The configuration differing from that of the first embodiment is described below.

Prior to describing the air entrapment detection process, a first period and a second period are defined. The first period corresponds to a period, within one reciprocating period of the plunger 50, during which the plunger 50 moves one way in the first direction (i.e., moves from the second end to the first end of the travel path). The second period corresponds to a period during which the plunger 50 moves one way in the second direction (i.e., from the first end to the second end of the travel path). Furthermore, a first level and a second level are defined. The first level is an evaluation value indicating the magnitude of the load physical quantity in the first period. The second level is an evaluation value indicating the magnitude of the load physical quantity in the second period. The first level indicates the approximate level of the load physical quantity in the first period, and the second level indicates the approximate level of the load physical quantity in the second period. The first and second levels may be represented by any numerical values. In the fourth embodiment, the first and second levels are the average value or the maximum value. That is, the first level is the average or maximum value of the load physical quantity in the first period, and the second level is the average or maximum value of the load physical quantity in the second period.

In the fourth embodiment as well, the air entrapment detector 90 determines that air entrapment has occurred based on the actual operating amount satisfying a specified requirement during operation of the motor 20. The fourth embodiment differs from the first through third embodiments in the actual operating amount and the specified requirement.

In the first through third embodiments, the actual operating amount was the amplitude of the filtered physical quantity (specifically, the moving average of the load physical quantity).

In contrast, the actual operating amount in the fourth embodiment is a reciprocating difference based on the load physical quantity in one reciprocating period of the plunger 50. The reciprocating difference is a difference between the first level and the second level in one reciprocating period.

The air entrapment detector 90 may calculate the reciprocating difference based on any load physical quantity. In the fourth embodiment, the load physical quantity is the motor current value, as in the first embodiment. That is, the first level is the average or maximum value of the motor current value in the first period, and the second level is the average or maximum value of the motor current value in the second period. The difference between the first and second levels is the reciprocating difference.

In the fourth embodiment, the air entrapment detector 90 calculates the reciprocating difference for each reciprocation of the plunger 50. The air entrapment detector 90 then determines that air entrapment has occurred if the reciprocating difference satisfies a specified requirement. In the fourth embodiment, the specified requirement includes the reciprocating difference being less than or equal to a second current threshold.

As illustrated in FIG. 8, the second load fluctuates approximately periodically, with one cycle as a one-way movement of the slider 48. Therefore, calculating the reciprocating difference is synonymous with reducing or removing the component attributable to the second load from the motor current value. Consequently, by comparing the reciprocating difference with the second current threshold, the influence of the second load can be reduced or removed enabling accurate detection of air entrapment. Since the third load is constant or nearly constant, the component attributable to the third load is also significantly reduced or removed in the reciprocating difference.

The air entrapment detector 90 can detect the direction of movement of the plunger 50 (i.e., whether the current period corresponds to the first period or the second period) based on the first and second slider position signals from the position detector 95.

The position detector 95 may include only one of the first and second detectors 96A and 96B. For example, if the position detector 95 includes only the first detector 96A, the air entrapment detector 90 can grasp (i.e., detect) the position of the plunger 50 based on the first slider position signal and the first through third rotation signals. Specifically, the air entrapment detector 90, upon receiving the first slider position signal, determines that the plunger 50 has reached its lowest end (the aforementioned fourth state) at the timing of that reception. After receiving the first slider position signal, the air entrapment detector 90 detects the amount of rotation (i.e., the rotation angle) of the motor 20 after receiving the first slider position signal, based on the first through third rotation signals. The amount of rotation of the motor 20 required to move the plunger 50 from the first end to the second end within the reciprocating range is known (e.g., N rotations). Therefore, after receiving the first slider position signal, the air entrapment detector 90 can determine that the plunger 50 has reached the uppermost end (the aforementioned second state) in response to the motor 20 having rotated N times. In this manner, the air entrapment detector 90 can determine the timing when the plunger 50 reaches the uppermost end and the timing when the plunger 50 reaches the lowermost end. The air entrapment detector 90 can determine the first period and the second period based on these timings and can calculate the first level and the second level based on these first period and second period.

The air entrapment detector 90 acquires the first level of the motor current value in the first period (or second period) and acquires the second level of the motor current value in the subsequent second period (or first period). The air entrapment detector 90 then calculates the reciprocating difference between the first level and the second level acquired immediately before, based on the second period having elapsed. The air entrapment detector 90 determines whether air entrapment has occurred based on the reciprocating difference. The air entrapment detector 90 may treat the second period and the subsequent first period as one reciprocation of the plunger 50 and calculate the reciprocating difference for each such reciprocation.

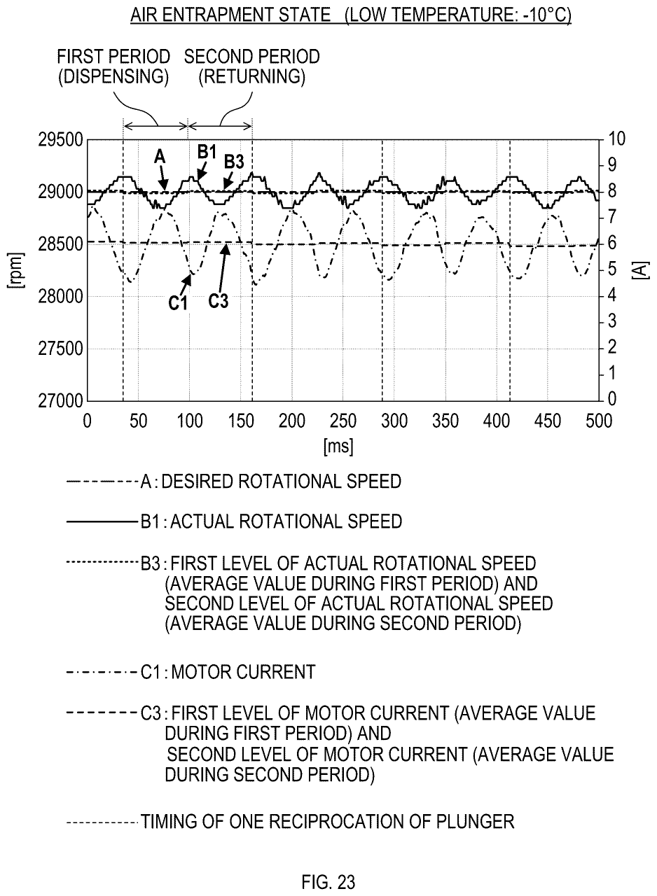

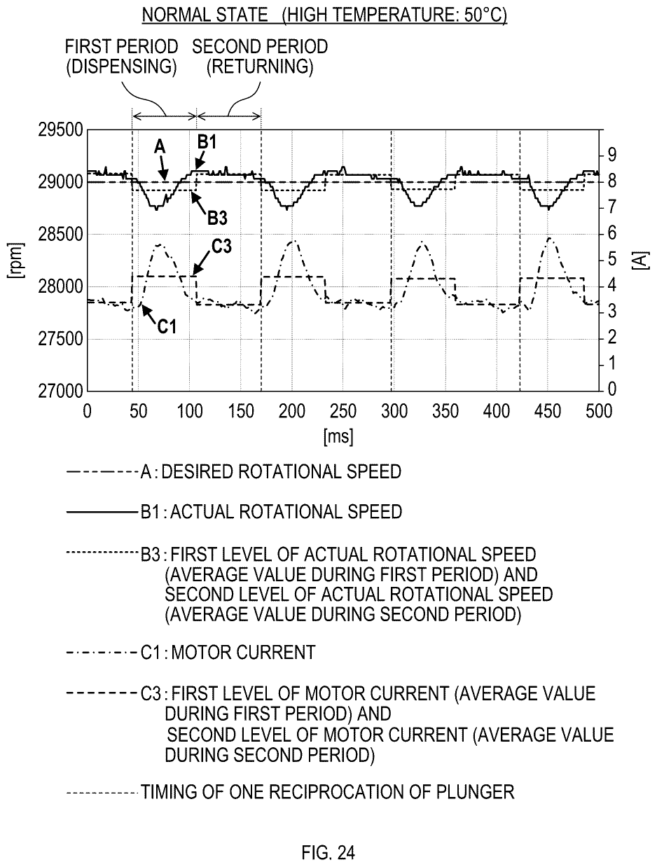

As illustrated in FIG. 23, in the air entrapped state and a low temperature environment, the fluctuation in the motor current value becomes large despite occurrence of air entrapment, and the difference between that fluctuation and the fluctuation in the normal state is small. However, the difference between the first level and the second level of the motor current value (i.e., the reciprocating difference) is very small. The first level and second level in FIGS. 23 and 24 illustrate average values.

The same applies to the actual rotational speed. That is, in a low-temperature environment, even when air entrapment occurs, the fluctuation in the actual rotational speed is large, and the difference between that fluctuation and the fluctuation in the normal state is small. However, the difference between the first level and the second level of the actual rotational speed (i.e., the reciprocating difference) is very small.

On the other hand, in the normal state and a high-temperature environment, as illustrated in FIG. 24, both the reciprocating difference in motor current value and the reciprocating difference in the actual rotational speed have a certain magnitude corresponding to the pressure from the grease. The magnitudes of these reciprocating differences are sufficiently larger than that in the air entrapped state and a low-temperature environment, as is evident when compared to those in FIG. 23.

The load torque applied to motor 20 also includes components attributable to the second load (and the third load). However, although not shown, the effect of the second load (and the third load) on the reciprocating difference of the load torque is significantly reduced. Consequently, the reciprocating difference of the load torque in the normal state is sufficiently larger than the reciprocating difference of the load torque in the air entrapped state.

Therefore, based on the reciprocating difference in the motor current value, air entrapment can be accurately detected over a wide temperature range. Similarly, air entrapment can be accurately detected using the reciprocating difference in the actual rotational speed and the reciprocating difference in the load torque. A fifth embodiment described later exemplifies air entrapment detection based on the reciprocating difference of the actual rotational speed, and a sixth embodiment described later exemplifies air entrapment detection based on the reciprocating difference of the load torque.

The second current threshold may be set to a value smaller than a seventh expected range and larger than an eighth expected range. The seventh expected range is a range of the reciprocating difference in the motor current value expected in the normal state. The eighth expected range is a range of the reciprocating difference in the motor current values expected in the air entrapped state. The second current threshold may be smaller than a minimum value of the seventh expected range and larger than a maximum value of the eighth expected range.

The second current threshold may be a fixed value. In the fourth embodiment, the second current threshold is variably set in accordance with the operating state of the electric-powered lubricant dispenser 1, similar to the first current threshold in the first embodiment.

Specifically, the second current threshold may be set in accordance with the desired rotational speed. More specifically, the second current threshold may be set in the same manner as the first current threshold. For example, the vertical axis in FIG. 15 may be interpreted as the second current threshold. Furthermore, for example, the second current threshold may be set in accordance with various operating states in the same manner as the first current threshold.

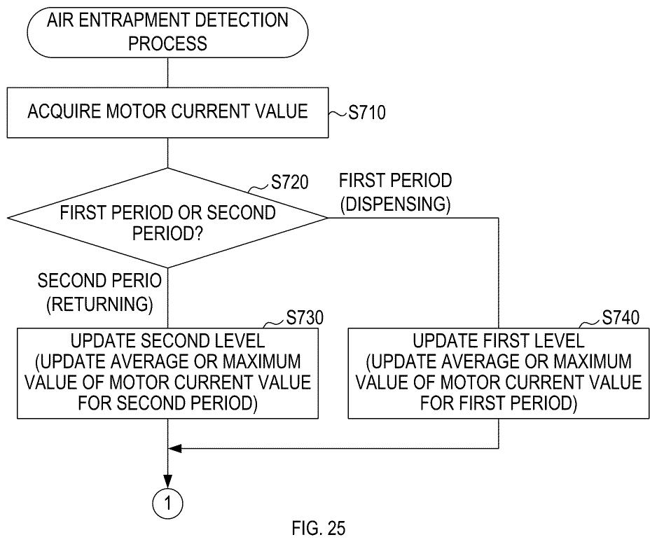

To achieve such air entrapment detection, in the fourth embodiment, in S350 in FIG. 18, the air entrapment detection process shown in FIG. 25 is executed instead of the air entrapment detection process shown in FIG. 19.

The control circuit 80, when proceeding to the air entrapment detection process in FIG. 25, acquires the motor current value in S710.

In S720, the control circuit 80 determines whether the current period is the first period or the second period. This determination can be made based on the first slider position signal and the second slider position signal, as described above. Alternatively, this determination can be made based on the first slider position signal or the second slider position signal and the first through third rotation signals.

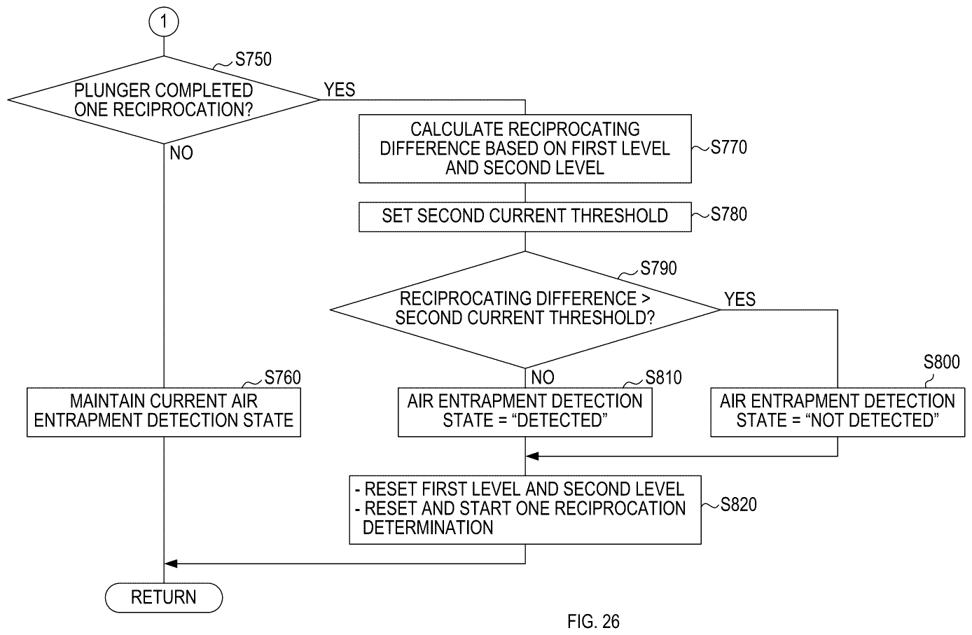

If the current period is the first period (i.e., plunger 50 is moving in the first direction), the process proceeds to S740. In S740, the control circuit 80 updates the first level (average or maximum value) of the motor current value for the first period. If the first level is the average value, the control circuit 80 calculates the average value for the first period, including the newly acquired motor current value. The control circuit 80 then updates the currently held average value with the calculated average value. If the first level is the maximum value and the newly acquired motor current value is greater than the currently held maximum value, the control circuit 80 updates the currently held maximum value with the newly acquired motor current value. After S740, the process proceeds to S750 (see FIG. 26).

If the current period is the second period (i.e., the plunger 50 is moving in the second direction) in S720, the process proceeds to S730. In S730, the control circuit 80 updates the second level (average or maximum value) of the motor current value for the second period in the same manner as in S740. After S730, the process proceeds to S750 (see FIG. 26).

In S750, the control circuit 80 determines whether the plunger 50 has completed one reciprocation, as in S530 in FIG. 19. If the plunger 50 has not yet completed one reciprocation, the process proceeds to S760. In S760, the control circuit 80 maintains the current air entrapment detection state.

If the plunger 50 has completed one reciprocation in S750, the process proceeds to S770. In S770, the control circuit 80 calculates the reciprocating difference based on the currently held first level and second level.

In S780, the control circuit 80 sets the second current threshold. Specifically, as described above, the control circuit 80 sets the second current threshold based on the desired rotational speed, the duty ratio, the actual rotational speed, or the device temperature.

In S790, the control circuit 80 determines whether the reciprocating difference calculated in S770 is greater than the second current threshold. If the reciprocating difference is greater than the second current threshold, the process proceeds to S800. In this case, the control circuit 80 determines that air entrapment has not occurred and sets the air entrapment detection state to “Not Detected”. If the reciprocating difference is less than or equal to the second current threshold, the process proceeds to S810. In this case, the control circuit 80 determines that air entrapment has occurred and sets the air entrapment detection state to “Detected”. After S800 or S810, the process proceeds to S820.

In S820, the control circuit 80 resets the currently held first level and second level. The control circuit 80 further resets the result of determination in S340 that the plunger 50 has completed one reciprocation and restarts the determination of whether the plunger 50 has completed one reciprocation.

### 2-5. Fifth Embodiment

The fifth embodiment describes yet another example of the air entrapment detection process. The electric-powered lubricant dispenser of the fifth embodiment is configured essentially the same as the electric-powered lubricant dispenser of the fourth embodiment, except for part of the air entrapment detection process. That is, the electric-powered lubricant dispenser of the fifth embodiment also executes the processes shown in FIGS. 16 through 18 and FIG. 20. The configuration differing from that of the fourth embodiment is described below.

The difference between the fifth embodiment and the fourth embodiment lies in the load physical quantity used to calculate the reciprocating difference. In the fourth embodiment, the load physical quantity was the motor current value. In contrast, the load physical quantity in the fifth embodiment is the actual rotational speed of the motor 20, as in the second embodiment. Specifically, in the fifth embodiment, the first level is the average or minimum value of the actual rotational speed in the first period, and the second level is the average or minimum value of the actual rotational speed in the second period. The difference between these first and second levels is the reciprocating difference.

In the fifth embodiment, the air entrapment detector 90 calculates the reciprocating difference based on the actual rotational speed during each reciprocating period of the plunger 50. The air entrapment detector then determines that air entrapment has occurred if this reciprocating difference satisfies a specified requirement. In the fifth embodiment, the specified requirement includes the reciprocating difference being less than or equal to the second speed threshold.

The second speed threshold may be a fixed value. In the fifth embodiment, the second speed threshold is variably set in accordance with the operating state of the electric-powered lubricant dispenser, in the same manner as the first speed threshold in the second embodiment.

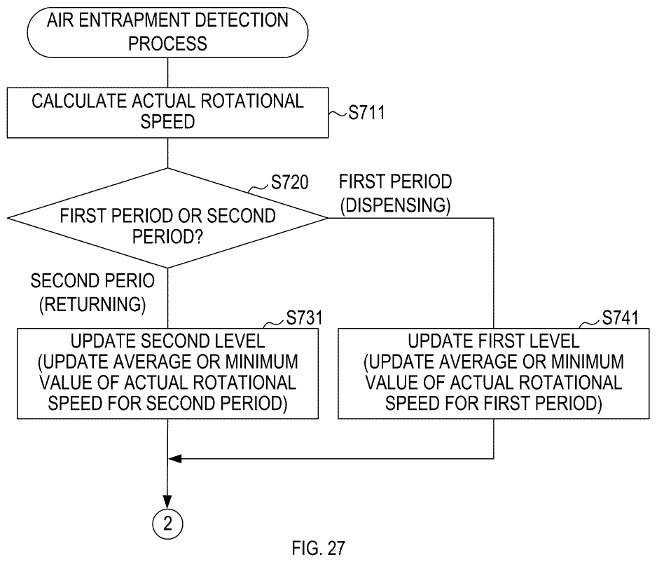

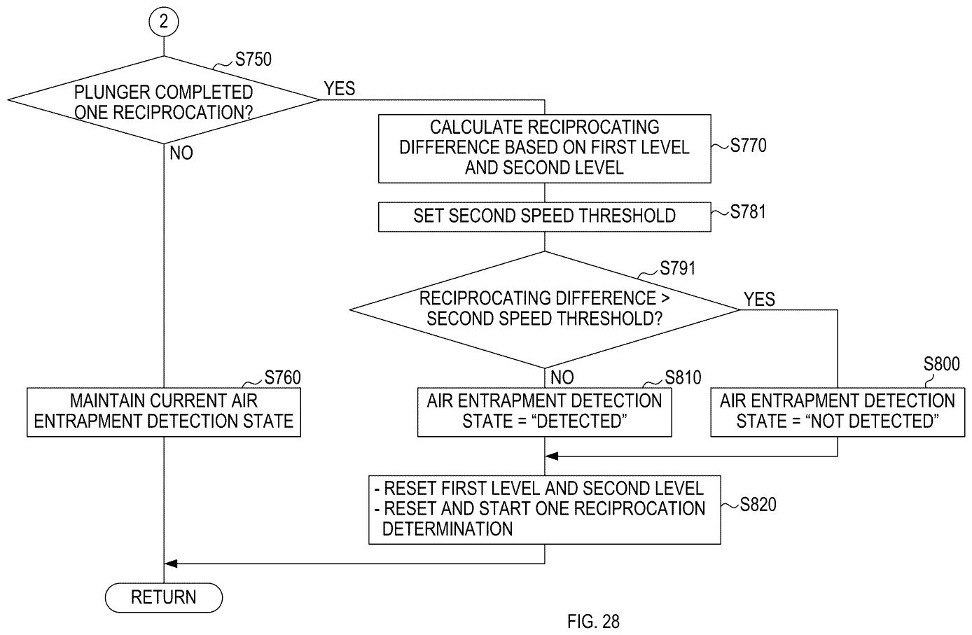

To achieve such air entrapment detection, in the fifth embodiment, in S350 in FIG. 18, the air entrapment detection process shown in FIGS. 27 and 28 is executed instead of the air entrapment detection process shown in FIGS. 25 and 26.

The air entrapment detection process of FIGS. 27 and 28 differs from that of FIGS. 25 and 26 in that S711, S731, S741, S781, and S791 are executed instead of S710, S730, S740, S780, and S790, respectively. Processes identical to those in the air entrapment detection process of FIGS. 25 and 26 are labeled with the same reference numerals as in FIGS. 25 and 26, and detailed descriptions thereof are omitted.

In S711, the control circuit 80 calculates the current actual rotational speed.

In S741, the control circuit 80 updates the first level (average or minimum value) of the actual rotational speed in the first period in the same manner as in S740 (FIG. 25).

In S731, the control circuit 80 updates the second level (average or minimum value) of the actual rotational speed in the second period in the same manner as in S730 (FIG. 25).

In S781, the control circuit 80 sets the second speed threshold. Specifically, the control circuit 80 sets the second speed threshold based on the desired rotational speed, the duty ratio, the actual rotational speed, or the device temperature, as described above.

In S791, the control circuit 80 determines whether the reciprocating difference calculated in S770 is greater than the second speed threshold. If the reciprocating difference is greater than the second speed threshold, the process proceeds to S800. In this case, it is determined that air entrapment has not occurred, and the air entrapment detection state is set to “Not Detected”.

If the reciprocating difference is less than or equal to the second speed threshold, the process proceeds to S810. In this case, it is determined that air entrapment has occurred, and the air entrapment detection state is set to “Detected”.

### 2-6. Sixth Embodiment

The sixth embodiment describes yet another example of the air entrapment detection process. The electric-powered lubricant dispenser of the sixth embodiment is configured essentially the same as the electric-powered lubricant dispenser of the fourth embodiment, except for part of the air entrapment detection process. That is, the electric-powered lubricant dispenser of the sixth embodiment also executes the processes shown in FIGS. 16 through 18 and FIG. 20. The configuration differing from that of the fourth embodiment is described below.

The difference between the sixth embodiment and the fourth embodiment lies in the load physical quantity used to calculate the reciprocating difference. The load physical quantity in the sixth embodiment is the load torque of the motor 20, as in the third embodiment. That is, in the sixth embodiment, the first level is the average or maximum value of the load torque in the first period, and the second level is the average or maximum value of the load torque in the second period. The difference between these first and second levels is the reciprocating difference.

In the sixth embodiment, the air entrapment detector 90 calculates the reciprocating difference based on the load torque during each reciprocating period of the plunger 50. The air entrapment detector 90 then determines that air entrapment has occurred if the reciprocating difference satisfies a specified requirement. In the sixth embodiment, the specified requirement includes the reciprocating difference being less than or equal to the second torque threshold.

The second torque threshold may be a fixed value. In the sixth embodiment, the second torque threshold is variably set in accordance with the operating state of the electric-powered lubricant dispenser 1, in the same manner as the first torque threshold in the third embodiment.

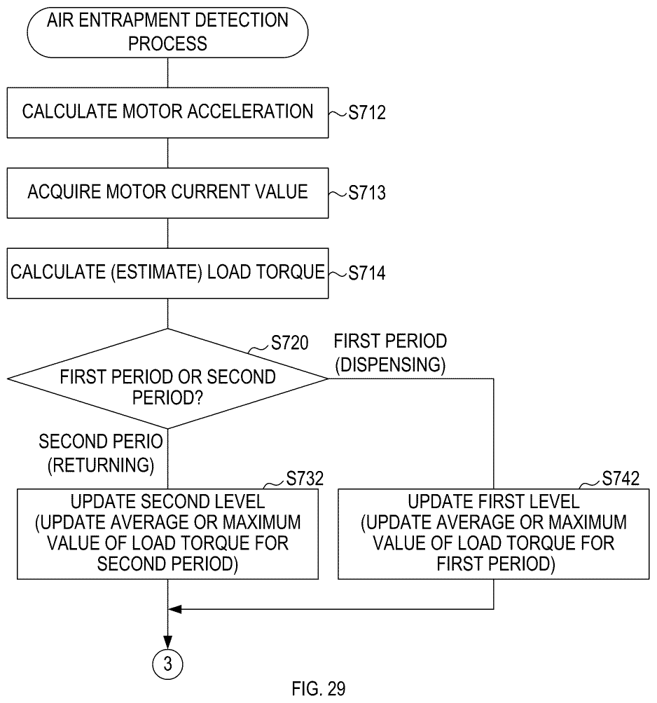

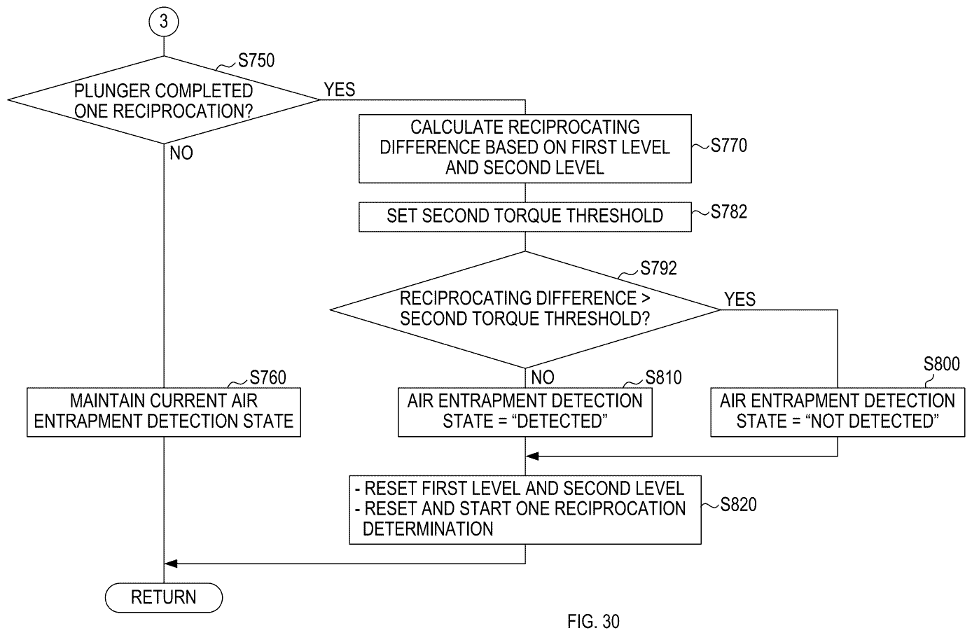

To achieve such air entrapment detection, in the sixth embodiment, in S350 in FIG. 18, the air entrapment detection process shown in FIGS. 29 and 30 is executed instead of the air entrapment detection process shown in FIGS. 25 and 26.

The air entrapment detection process of FIGS. 29 and 30 differs from the air entrapment detection process of FIGS. 25 and 26 in that (i) S712 through S714 are executed instead of S710, and (ii) S731, S741, S781, and S791 are executed instead of S730, S740, S780, and S790, respectively. Processes identical to those in the air entrapment detection process in FIGS. 25 and 26 are labeled with the same reference numerals as in FIGS. 25 and 26, and detailed descriptions thereof are omitted.

In S712, the control circuit 80 calculates the current actual rotational speed and calculates the motor acceleration based on the actual rotational speed.

In S713, the control circuit 80 acquires the motor current value based on the current detection signal.

In S714, the control circuit 80 calculates the load torque based on the above formula (1), using the motor acceleration and motor current value obtained in S712 and S713.

In S742, the control circuit 80 updates the first level (average or maximum value) of the load torque for the first period in the same manner as in S740 (FIG. 25).

In S732, the control circuit 80 updates the second level (average or maximum value) of the load torque for the second period in the same manner as in S730 (FIG. 25).

In S782, the control circuit 80 sets the second torque threshold. Specifically, as described above, the control circuit 80 sets the second torque threshold based on the desired rotational speed, the duty ratio, the actual rotational speed, or the device temperature, among other factors.

In S792, the control circuit 80 determines whether the reciprocating difference calculated in S770 is greater than the second torque threshold. If the reciprocating difference is greater than the second torque threshold, the process proceeds to S800. In this case, it is determined that air entrapment has not occurred, and the air entrapment detection state is set to “Not Detected”.

If the reciprocating difference is less than or equal to the second torque threshold, the process proceeds to S810. In this case, it is determined that air entrapment has occurred, and the air entrapment detection state is set to “Detected”.

### 2-7. Other Embodiments

The embodiments of the present disclosure have been described above, but the present disclosure is not limited to the above embodiments and may be practiced in various forms.
(2-7-1) The load physical quantity used for air entrapment detection may differ from the motor current value, the actual rotational speed, and the load torque.
(2-7-2) Each threshold, such as the first current threshold and the first speed threshold, may be set based on an operating state different from the operating states (desired rotational speed, duty ratio, actual rotational speed, or device temperature) exemplified in the above embodiments. Each threshold may be set based on any operating state of the electric-powered lubricant dispenser 1. Each threshold may be set based on a load-related operating state. The load-related operating state is an operating state that affects the motor load. That is, the motor load may change in response to changes in the load-related operating state.

For example, the operating state may be a battery voltage. That is, each threshold may be set in accordance with the magnitude of the battery voltage. Even if the duty ratio remains constant, a decrease in the battery voltage reduces the electric power supplied to the motor 20, thereby decreasing the output of the motor 20. Therefore, each threshold may be set to decrease as the battery voltage decreases. To achieve this, the electric-powered lubricant dispenser 1 may include a voltage detector that detects the battery voltage. The voltage detector may be configured (i) to receive the battery voltage and (ii) to output a voltage detection signal corresponding to the magnitude of the battery voltage to the control circuit 80. The control circuit 80 may (i) acquire the magnitude of the battery voltage based on the voltage detection signal from the voltage detector and (ii) set each threshold based on the acquired magnitude.
(2-7-3) In the above embodiments, the notification process and temporary suspension of the accumulation of the actual reciprocating count are exemplified as specified processes executed when air entrapment is detected. However, when air entrapment is detected, other specified processes may be executed in addition to or instead of these processes.
(2-7-4) The electric-powered lubricant dispenser 1 may be configured to dispense a lubricant other than grease. Such lubricant may be, for example, semi-solid or liquid.
(2-7-5) The rotational speed range, the operation mode, and the desired reciprocating count may be set by methods different from those of the above embodiments. For example, a user interface (e.g., buttons, dials, levers, touch panels, etc.) that is different in form from the second and third switches 72, 73 for setting the operation mode may be provided. The operation mode may then be switched in response to operation of the user interface. The same applies to the desired reciprocating count. The rotational speed range may also be switched in accordance with operation of a user interface (e.g., buttons, dials, levers, touch panels, etc.) in the form different from the first switch 71.
(2-7-6) In the above embodiments, the rotational state of the motor 20 (i.e., rotational position and actual rotational speed) is acquired using the first through third rotational position sensors 28A through 28C. However, the rotational state may be acquired by other methods. For example, so-called sensorless control may be employed in the electric-powered lubricant dispenser 1. That is, the rotational state of the motor 20 may be acquired based on the induced voltage generated in each of the three coils 24 of the motor.

### 2-8. Supplementary Notes

Multiple functions achieved by a single component in the above embodiments may be achieved by multiple components, and a single function achieved by a single component may be achieved by multiple components. Furthermore, multiple functions achieved by multiple components may be achieved by a single component, and a single function achieved by multiple components may be achieved by a single component. Also, some components of the above embodiments may be omitted. Additionally, at least part of the configuration of one embodiment may be added to or substituted for the configuration of another embodiment.

What is claimed is:

1. An electric-powered lubricant dispenser comprising:
a pump including:
a container configured to store a lubricant; and
a reciprocating member configured (i) to reciprocate in a first direction and a second direction opposite thereto within the container, and (ii) to dispense the lubricant in the container to outside the container in response to the reciprocating member moving in the first direction;
a motor configured to drive the reciprocating member and receive a motor load, the motor load including (i) a first load applied from the reciprocating member to the motor due to a pressure that the reciprocating member receives from the lubricant, and (ii) a second load applied to the motor from the reciprocating member independent of the pressure;
a drive circuit configured to drive the motor; and
a control circuit configured to rotate the motor via the drive circuit, and perform a specified process based on an actual operating amount of the motor satisfying a specified requirement during driving of the motor, the specified requirement being a condition indicating that gas is present in the container, the actual operating amount having a magnitude corresponding to a magnitude of a specific load, the specific load (i) being at least part of the motor load, and (ii) including the first load and not including at least part of the second load.

2. The electric-powered lubricant dispenser according to claim 1,
wherein the pump includes a guide that supports the reciprocating member so that the reciprocating member can reciprocate, and
wherein the reciprocating member is configured to move along the guide.

3. The electric-powered lubricant dispenser according to claim 2,
wherein the reciprocating member includes:
a plunger (i) at least partially disposed in the container, and (ii) configured to reciprocate in the first direction and the second direction within the container; and
a slider (i) mechanically coupled to the plunger, and (ii) configured to move integrally with the plunger along the guide.

4. The electric-powered lubricant dispenser according to claim 1,
wherein the actual operating amount includes an amplitude of a filtered physical quantity, the filtered physical quantity being obtained by reducing or removing a component attributable to the second load from a load physical quantity, the load physical quantity being a physical quantity that varies depending on a magnitude of the motor load.

5. The electric-powered lubricant dispenser according to claim 4,
wherein the filtered physical quantity is a moving average of the load physical quantity.

6. The electric-powered lubricant dispenser according to claim 5,
wherein the moving average is an average of the load physical quantity during calculation target time, and
wherein the calculation target time is a half of required reciprocating time, the required reciprocating time being time required for the reciprocating member to complete one reciprocation.

7. The electric-powered lubricant dispenser according to claim 6,
wherein the control circuit is configured:
to set a desired rotational speed that is a desired value of a rotational speed of the motor;
to control the drive circuit so that an actual rotational speed of the motor is consistent with the desired rotational speed;
to acquire the calculation target time based on the set desired rotational speed; and
to calculate the moving average based on the acquired calculation target time.

8. The electric-powered lubricant dispenser according to claim 4,
wherein the specified requirement is satisfied based on a maximum value of the amplitude of the filtered physical quantity within a specified drive period being less than or equal to a first threshold.

9. The electric-powered lubricant dispenser according to claim 8,
wherein the control circuit is configured to set the first threshold in accordance with an operating state of the electric-powered lubricant dispenser.

10. The electric-powered lubricant dispenser according to claim 4,
wherein the drive circuit is configured to supply electric current to the motor to rotate the motor, and
wherein the load physical quantity includes a magnitude of the electric current that is being supplied from the drive circuit to the motor.

11. The electric-powered lubricant dispenser according to claim 4,
wherein the load physical quantity includes an actual rotational speed of the motor.

12. The electric-powered lubricant dispenser according to claim 4,
wherein the load physical quantity includes a load torque, and the load torque is a torque being applied to the motor from outside the motor.

13. The electric-powered lubricant dispenser according to claim 1,
wherein the actual operating amount includes a reciprocating difference of a load physical quantity in one reciprocating period, the one reciprocating period corresponding to a period during which the reciprocating member completes one reciprocation, the load physical quantity being a physical quantity that varies depending on a magnitude of the motor load, and
wherein the reciprocating difference is a difference between a first level and a second level, the first level indicating a magnitude of the load physical quantity in a first period, the second level indicating a magnitude of the load physical quantity in a second period, the first period corresponding to a period, within the one reciprocating period, during which the reciprocating member moves in the first direction, the second period corresponding to a period, within the one reciprocating period, during which the reciprocating member moves in the second direction.

14. The electric-powered lubricant dispenser according to claim 13,
wherein the specified requirement is satisfied in response to the reciprocating difference being less than or equal to a second threshold.

15. The electric-powered lubricant dispenser according to claim 14,
wherein the control circuit is configured to set the second threshold in accordance with an operating state of the electric-powered lubricant dispenser.

16. The electric-powered lubricant dispenser according to claim 13,
wherein the drive circuit is configured to supply electric current to the motor to rotate the motor,
wherein the load physical quantity includes a magnitude of the electric current that is being supplied from the drive circuit to the motor,
wherein the first level is an average or maximum value of the magnitude of the electric current in the first period, and
wherein the second level is an average or maximum value of the magnitude of the electric current in the second period.

17. The electric-powered lubricant dispenser according to claim 13,
wherein the load physical quantity includes an actual rotational speed of the motor,
wherein the first level is an average or minimum value of the actual rotational speed in the first period, and
wherein the second level is an average or minimum value of the actual rotational speed in the second period.

18. The electric-powered lubricant dispenser according to claim 13,
wherein the load physical quantity includes a load torque that is a torque being applied to the motor from outside the motor,
wherein the first level is an average or maximum value of the load torque in the first period, and
wherein the second level is an average or maximum value of the load torque in the second period.

19. The electric-powered lubricant dispenser according to claim 13, comprising:
a position detector configured to output a position signal corresponding to a position of the reciprocating member,
wherein the control circuit is configured:
to receive the position signal; and
to calculate the reciprocating difference based on the first level in the first period determined based on the position signal and the second level in the second period determined based on the position signal.

20. The electric-powered lubricant dispenser according to claim 9, wherein the control circuit is configured:
to set a desired rotational speed that is a desired value of a rotational speed of the motor; and
to control the drive circuit so that an actual rotational speed of the motor is consistent with the desired rotational speed, and
wherein the operating state includes the desired rotational speed.

21. The electric-powered lubricant dispenser according to claim 9,
wherein the control circuit is configured to output a pulse width modulated signal having a duty ratio to the drive circuit to control the drive circuit,
wherein the drive circuit is configured (i) to receive the pulse width modulated signal, and (ii) to drive the motor in accordance with the duty ratio of the received pulse width modulated signal, and
wherein the operating state includes the duty ratio.

22. The electric-powered lubricant dispenser according to claim 9,
wherein the operating state includes an actual rotational speed of the motor.

23. The electric-powered lubricant dispenser according to claim 9,
wherein the control circuit is configured to acquire a temperature of the electric-powered lubricant dispenser, and
wherein the operating state includes the temperature.

24. The electric-powered lubricant dispenser according to claim 1, further comprising:
a notifier configured to notify a user of the electric-powered lubricant dispenser of information indicating that the gas is present in the container,
wherein the specified process includes notifying the user of the information via the notifier.

25. The electric-powered lubricant dispenser according to claim 1,
wherein the control circuit is configured:
to accumulate an actual reciprocating count of the reciprocating member during driving of the motor; and
to stop the motor based on the actual reciprocating count having reached a desired reciprocating count, and
wherein the specified process includes temporarily stopping accumulation of the actual reciprocating count.

26. The electric-powered lubricant dispenser according to claim 25,
wherein the control circuit is configured, after temporarily stopping the accumulation of the actual reciprocating count, to resume the accumulation of the actual reciprocating count based on the actual operating amount no longer satisfying the specified requirement.

27. The electric-powered lubricant dispenser according to claim 1,
wherein the control circuit is configured to stop the motor based on a state in which the actual operating amount satisfies the specified requirement having continued for a specified time during driving of the motor.

28. The electric-powered lubricant dispenser according to claim 1,
wherein the control circuit is configured to detect that the gas is present in the container and/or the pump is about to dispense the gas, in response to the specified requirement being satisfied during driving of the motor.

29. A method for dispensing a lubricant from an electric-powered lubricant dispenser, the method comprising:
dispensing the lubricant in a container by reciprocating a reciprocating member by a motor, the motor being configured to receive a motor load, the motor load including (i) a first load applied to the motor from the reciprocating member due to a pressure that the reciprocating member receives from the lubricant and (ii) a second load applied to the motor from the reciprocating member independent of the pressure; and
performing a specified process based on an actual operating amount satisfying a specified requirement during driving of the motor, the specified requirement being a condition indicating that gas is present in the container, the actual operating amount having a magnitude corresponding to a magnitude of a specific load, the specific load (i) being at least part of the motor load and (ii) including the first load and not including at least part of the second load.
